(19) United States
(12) Patent Application Publication
(10) Pub. No.: US 2024/0129019 A1
(43) Pub. Date: Apr. 18, 2024

(54) MASTER DEVICE, SLAVE DEVICE, REPEATER DEVICE, AND WIRELESS COMMUNICATION SYSTEM

(71) Applicant: OMRON Corporation, Kyoto-shi, Kyoto (JP)

(72) Inventor: Keisuke YANO, Kyoto-shi, Kyoto (JP)

(21) Appl. No.: 18/277,884

(22) PCT Filed: Feb. 22, 2022
(86) PCT No.: PCT/JP2022/007335

§ 371 Date: Aug. 18, 2023

(30) Foreign Application Priority Data
Mar. 4, 2021 (JP) 2021-034763

(51) Int. Cl. H04B 7/15; G08C 17/02

(52) U.S. Cl. CPC H04B 7/15; G08C 17/02

(57) ABSTRACT

A master device receives a signal directly or via a repeater device from a slave device. When receiving a slave signal from the slave device, the repeater device transmits a repeater signal wirelessly to the slave device and the master device. The master device comprises: a master device receive unit that receives the slave signal and the repeater signal; a master device transmit unit that transmits a response signal to the slave device and the repeater device when the master device receive unit receives the repeater signal; and an output unit that outputs a control signal to a device to be controlled, when the master device receive unit receives at least one of the slave signal and the repeater signal.

### TECHNICAL FIELD

The present disclosure relates to a master device, a slave device, a repeater device, and a wireless communication system.

### BACKGROUND ART

A wireless communication system for wirelessly controlling a device to be controlled has been put to practical use. For example, Patent Document 1 discloses a wireless communication system that performs bidirectional wireless communication via a repeater device between a control device and a controlled device controlled thereby.

### PRIOR ART DOCUMENT

### Patent Document

Patent Document 1: JP201472791A
Patent Document 2: JP201898753A

### Non-Patent Literature

Non-patent Literature 1: “Wireless Facility Standards for 920 MHz Band Telemeter, Telecontrol, and Data Transmission”, (General Incorporated Association) Association of Radio Industries and Businesses, ARIB STD-T108, 1.3 Version, Updated on Apr. 12, 2019

### SUMMARY OF THE INVENTION

### Problem to be Solved by the Invention

In the conventional wireless communication system performing bidirectional wireless communication via a repeater device between a slave device and a master device controlled thereby, when a slave signal reaches both the repeater device and the master device, there is a problem that a repeater signal and a response signal transmitted in response to the slave signal from the repeater device and the master device, respectively, interfere with each other.

An object of the present disclosure is to provide a master device, a slave device, a repeater device, and a wireless communication system that are configured to prevent interference between a repeater signal transmitted from the repeater device and a response signal transmitted from the master device.

### Means for Solving Problem

A master device according to an aspect of the present disclosure is a master device receiving a signal directly or via a repeater device from a slave device,

when receiving a slave signal from the slave device, the repeater device transmitting a repeater signal wirelessly to the slave device and the master device,

the master device comprising:
a master device receive unit that receives the slave signal and the repeater signal;
a master device transmit unit that transmits a response signal to the slave device and the repeater device when the master device receive unit receives the repeater signal; and
an output unit that outputs a control signal to a device to be controlled, when the master device receive unit receives at least one of the slave signal and the repeater signal, wherein
when the master device receive unit receives the slave signal, the master device transmit unit transmits the response signal to the slave device and the repeater device after a predetermined wait time.

A slave device according to another aspect of the present disclosure is a slave device transmitting a signal directly or via a repeater device to a master device of the above aspect,

the slave device comprising:
a slave device transmit unit that transmits the slave signal wirelessly to the repeater device;
a slave device receive unit that receives the repeater signal and the response signal; and
a slave device notification unit for notifying a user of information, wherein
when the slave device receive unit receives at least one of the repeater signal and the response signal within a predetermined response time from time of transmission of the slave signal by the slave device transmit unit, the slave device notification unit notifies the user of information indicating that reception has succeeded.

A repeater device according to another aspect of the present disclosure comprises:
a repeater device receive unit that receives a slave signal transmitted wirelessly from a slave device and the response signal transmitted wirelessly from a master device of the above aspect; and
a repeater device transmit unit that transmits the repeater signal wirelessly to the slave device and the master device, based on the slave signal.

A wireless communication system according to another aspect of the present disclosure comprises a master device, a slave device, and a repeater device, of the above aspects.

### Effect of the Invention

According to the master device, slave device, repeater device, and wireless communication system of the present disclosure, interference is prevented between the repeater signal transmitted from the repeater device and the response signal transmitted from the master device.

### BRIEF DESCRIPTION OF DRAWINGS

FIG. 1A to FIG. 1C are diagrams showing an application example of a wireless communication system according to a first embodiment of the present disclosure.

FIG. 2 is a block diagram showing a configuration example of a slave device 1 of FIGS. 1A to FIG. 1C.

FIG. 3 is a block diagram showing a configuration example of a repeater device 2 of FIG. 1A to FIG. 1C.

FIG. 4 is a block diagram showing a configuration example of a master device 3 of FIGS. 1A to FIG. 1C.

FIG. 5 is a flowchart showing an example of processing executed by the slave device 1 of FIG. 2.

FIG. 6 is a flowchart showing an example of processing executed by the repeater device 2 of FIG. 3.

FIG. 7 is a flowchart showing an example of processing executed by the master device 3 of FIG. 4.

FIG. 8 is a sequence diagram showing an example of overall action of the wireless communication system 100 according to the first embodiment of the present disclosure.

FIG. 9 is a sequence diagram showing another example of overall action of the wireless communication system 100 according to the first embodiment of the present disclosure.

FIG. 10 is a sequence diagram showing yet another example of overall action of the wireless communication system 100 according to the first embodiment of the present disclosure.

FIG. 11 is a sequence diagram showing still another example of overall action of the wireless communication system 100 according to the first embodiment of the present disclosure.

FIG. 12A and FIG. 12B are diagrams showing an example of bidirectional wireless communication, via the repeater device 2, between the slave device 1 and the master device 3.

FIG. 13 is a flowchart showing an example of processing executed by the slave device 1 of the wireless communication system 100 according to a second embodiment of the present disclosure.

FIG. 14 is a flowchart showing an example of processing executed by the master device 3 of the wireless communication system 100 according to the second embodiment of the present disclosure.

FIG. 15 is a sequence diagram showing an example of overall action of the wireless communication system 100 according to the second embodiment of the present disclosure.

FIG. 16 is a diagram showing an application example of a wireless communication system 300 according to a third embodiment of the present disclosure.

FIG. 17 is a block diagram showing a configuration example of a slave device 301 according to the third embodiment of the present disclosure.

FIG. 18 is a table showing an example of ID correlation information 171 of FIG. 17.

FIG. 19 is a block diagram showing a configuration example of a repeater device 302 according to the third embodiment of the present disclosure.

FIG. 20 is a table showing an example of an ID conversion table 325 of FIG. 19.

FIG. 21 is a block diagram showing a configuration example of a master device 303 according to the third embodiment of the present disclosure.

FIG. 22 is a table showing an example of an output destination table 335 of FIG. 21.

FIG. 23 is a flowchart showing an example of processing executed by the slave device 301 of FIG. 17.

FIG. 24 is a flowchart showing an example of processing executed by the repeater device 302 of FIG. 19.

FIG. 25 is a flowchart showing an example of processing executed by the master device 303 of FIG. 21.

FIG. 26 is a sequence diagram showing an example of overall action of the wireless communication system 300 according to the third embodiment of the present disclosure.

### MODES FOR CARRYING OUT THE INVENTION

Embodiments of a wireless communication system according to the present disclosure will now be described with reference to the accompanying drawings. In the following embodiments, the same or like constituent elements are designated by the same reference numerals.

### 1. First Embodiment

### 1-1. Application Example

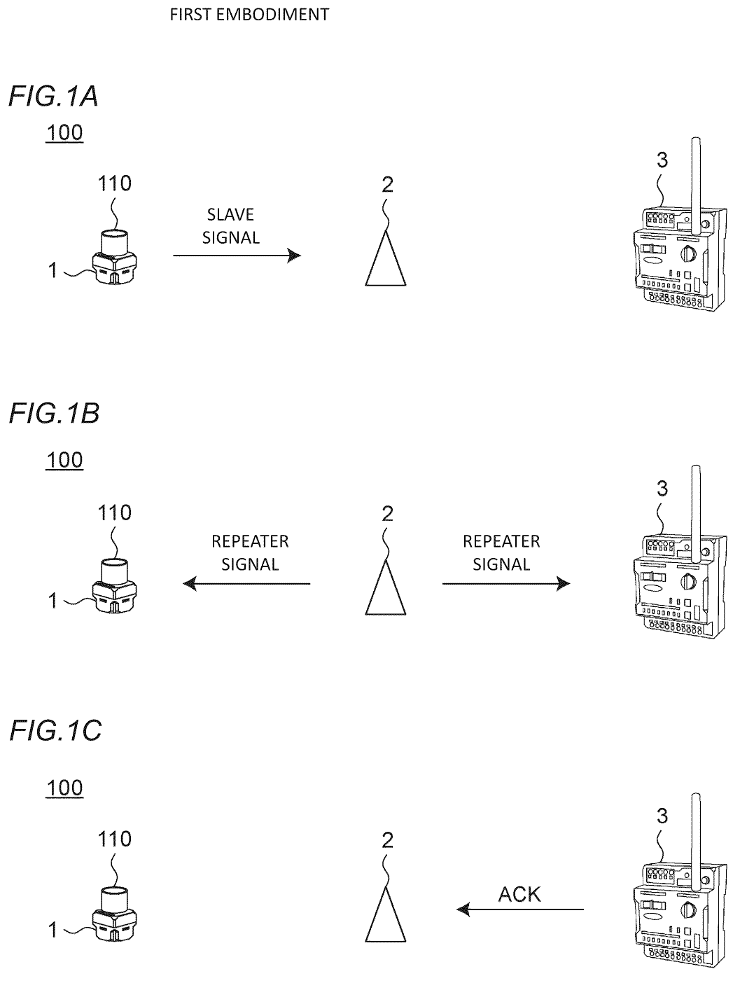

FIG. 1A to FIG. 1C are diagrams showing an application example of a wireless communication system 100 according to a first embodiment of the present disclosure. The wireless communication system 100 includes a slave device (transmitter) 1, a repeater device 2, and a master device (receiver) 3.

The slave device 1 is, for example, a user-portable wireless switch and includes a push-button transmit switch. When the transmit switch is pressed to turn on, the slave device 1 transmits a signal via the repeater device 2 to the master device 3. Based on the received signal, the master device 3 outputs a control signal to a device to be controlled such as a programmable logic controller (PLC), enabling operations, such as robot control, door opening/closing, and unmanned transport vehicle drive.

The slave device 1, the repeater device 2, and the master device 3 are wireless facilities that use radio waves with frequencies in, for example, 920 MHz band, e.g., 915 MHz to 930 MHz, e.g., 928.15 MHz to 929.65 MHz, and conform to, for example, ARIB STD-T108 standard defined in Non-patent Literature 1. The slave device 1 is, for example, wireless push-button A2 W-TA-WC1 manufactured by OMRON Corporation that uses a radio wave with a frequency of 929.2 MHz, and the master device 3 and the repeater device 2 are, for example, A2 W-RAN-WC1. The slave device 1, the repeater device 2, and the master device 3 are not limited to the above and may be any ones as long as they can perform wireless communication with one another. The slave device 1, the repeater device 2, and the master device 3 may be wireless facilities that conform to, for example, the communication standards such as ARIB STD-T67, ARIB STD-T93, etc.

In FIG. 1A when the user presses a button member 110 of the transmit switch, the slave device 1 transmits a slave signal to the repeater device 2.

In FIG. 1B the repeater device 2 having received the slave signal transmits a repeater signal to the slave device 1 and the master device 3. The slave device 1 having received the repeater signal notifies the user of information indicating success in reception by, e.g., lighting a display in green.

In FIG. 1C the master device 3 having received the repeater signal returns an acknowledgment signal (hereinafter referred to as “ACK signal”) to the repeater device 2 and transmits an output signal to the device to be controlled. The repeater device 2 receives the ACK signal transmitted from the master device 3. The ACK signal is an example of “response signal” of the present disclosure.

As compared with the conventional wireless communication system including the repeater device, the wireless communication system 100 configured as above can reduce reply time from transmission of the slave signal from the slave device 1 to the repeater device 2 in FIG. 1A up to return of the repeater signal from the repeater device 2 to the slave device 1 in FIG. 1B

The reason why the reply time can be reduced compared with the prior art is as follows.

From transmission of a slave signal from a slave device to a repeater device up to return of a repeater signal from the repeater device to the slave device, the conventional wireless communication system had to go through the following steps of:
(i) the slave device transmitting a slave signal to the repeater device;
(ii) the repeater device having received the slave signal transmitting a first repeater signal to the master device;
(iii) the master device having received the first repeater signal returning an ACK signal to the repeater device; and
(iv) the repeater device having received the ACK signal transmitting a second repeater signal to the slave device.

Here there is a restriction in communication standard that a predetermined time interval needs to be disposed between the steps (ii) and (iv) at which the repeater device transmits the signals.

That is, various communication standards stipulate that a control device for wireless facility shall have a transmission time limit function. For example, 3.4.1(3)2 of Non-patent Literature 1 defining ARIB STD-T108 stipulates that in the case of using a radio wave with a center frequency of 928.15 MHz to 929.65 MHz, when not performing carrier sense, the control device for wireless facility shall stop emitting the radio wave within 50 milliseconds (ms) and shall not emit again until a transmission downtime of 50 ms has elapsed. Note that 3.4.1(3)2 of Non-patent Literature 1 stipulates “only within consecutive 50 ms after first emission of the radio wave, retransmission may be possible without disposing the transmission downtime of 50 ms after stop of the emission.” In the description, consecutive predetermined time after first emission of a radio wave, capable of being retransmitted without the transmission downtime after the first emission of the radio wave, will be referred to as “retransmittable time”. In ARIB STD-T108 defined in Non-patent Literature 1, in the case of using the radio wave whose center frequency is 928.15 MHz to 929.65 MHz, the retransmittable time when not performing carrier sense is 50 ms.

In the conventional wireless communication system, the transmission downtime needs to be disposed between the step (ii) of transmitting the first repeater signal to the master device and the step (iv) of transmitting the second repeater signal to the slave device. Although it is also conceivable to execute the step (iv) within the retransmittable time posterior to the step (ii), there is a need to go through the step (iii) between the steps (ii) and (iv), rendering it difficult to execute the step (iv) within the retransmittable time.

Accordingly, in the conventional wireless communication system, for example, it took time exceeding the transmission downtime of 50 ms before the slave device receives the second repeater signal after transmitting the slave signal to the repeater device.

On the other hand, the wireless communication system 100 according to this embodiment can reduce the time from when the slave device transmits the slave signal to the repeater device to when it receives the second repeater signal, as compared with the conventional wireless communication system including the repeater device.

This time reduction effect is particularly advantageous in the case where the slave device 1 is a self-powered device that generates power as the user operates the transmit switch. Generally, such the self-powered slave device 1 can transmit the slave signal without using a primary battery or a secondary battery, eliminating the necessity for battery replacement and charging. Using the generated electric power, such the self-powered slave device 1 can more reliably transmit the slave signal and more reliably grasp the state of reception of the repeater signal. However, as in the conventional wireless communication system, for example, when it takes a long time greater than or equal to the transmission downtime of 50 ms for the slave device to receive the second repeater signal after transmission of the slave signal to the repeater device, electric power runs short, causing a problem that the state of reception of the repeater signal cannot be grasped. The wireless communication system 100 according to this embodiment solves the above problem since the time from when the slave device transmits the slave signal to the repeater device to when it receives the second repeater signal can be reduced as compared with a wireless communication system including the conventional repeater.

### 1-2. Configuration Example

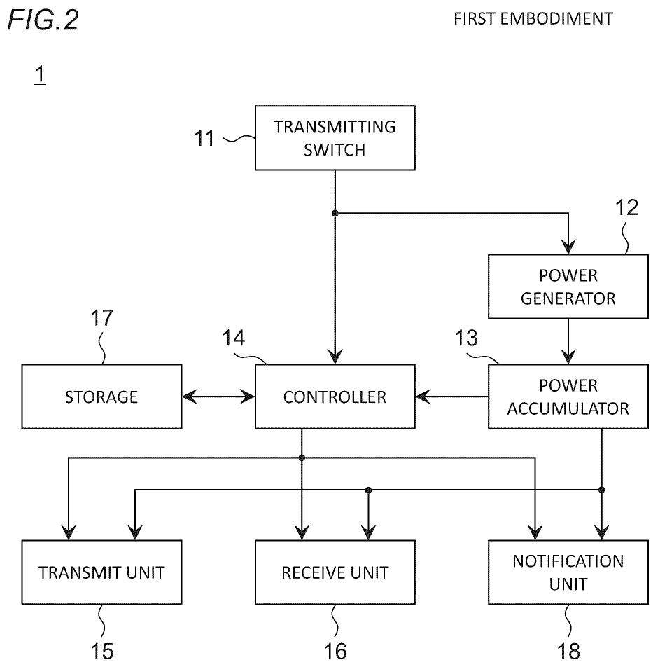

FIG. 2 is a block diagram showing a configuration example of the slave device 1 of FIG. 1. The slave device 1 includes a transmit switch 11, a power generator 12, a power accumulator 13, a controller 14, a transmit unit 15, a receive unit 16, a storage 17, and a notification unit 18.

The transmit switch 11 is a mechanical switch having the button member 110 to perform on-off switching by movement of the button member 110. When the button member 110 is pressed to turn on, the slave device 1 transmits a control signal.

The power generator 12 generates electric power by using energy generated with movement of the button member 110, for example, energy applied by the user to move the button member 110.

The power accumulator 13 is electrically connected to the power generator 12 and accumulates electric power generated by the power generator 12. The power accumulator 13 is, for example, a capacitor. The power accumulator 13 supplies accumulated electric power to constituent elements such as the controller 14, the transmit unit 15, the receive unit 16, and the notification unit 18.

The technique disclosed in Patent Document 2 (see, e.g., 0063 of Patent Document 2) capable of generating electric power by movement of the button member is applicable to the transmit switch 11, the power generator 12, and the power accumulator 13.

The controller 14 includes a central processing unit (CPU), a random access memory (RAM), a read only memory (ROM), etc., and controls action of the slave device 1 according to information processing. Such information processing is implemented by executing a program by the controller 14. The controller 14 may be configured from various semiconductor integrated circuits such as an MPU, a GPU, a DSP, an FPGA, and an ASIC, in addition to the CPU.

The storage 17 is a medium that stores recorded information such as a program by electrical, magnetic, optical, mechanical, or chemical action such that a computer or other device, machine, etc., can read the recorded information such as a program. The storage 17 is, for example, a nonvolatile memory capable of retaining memory without power supply, such as the ROM, a flash memory, a hard disk drive, or a solid state drive. The storage 17 stores individual identification information and a program, etc., executed by the controller 14.

The transmit unit 15 includes, for example, an antenna and transmits a slave signal in accordance with a command of the controller 14. The slave signal includes individual identification information. The individual identification information includes, for example, an identifier (ID) of the slave device 1 that is a transmission source and type information indicative of the type of a transmission source device. The ID and the type information are both an example of the “individual identification information” of the present disclosure. The type information includes information for identifying which the transmission source device is among the slave device 1, the repeater device 2, and the master device 3. For example, in the case where the transmission source device is the slave device 1, in the type information, the bit corresponding to the slave device 1 is set to High (H) level and the bit corresponding to the repeater device 2 and the bit corresponding to the master device 3 are set to Low (L) level.

The receive unit 16 includes, for example, an antenna and receives a repeater signal transmitted from the repeater device 2.

The notification unit 18 is a notification device for notifying the user of information indicative of success or failure in transmission/reception of a signal, communication status, etc. The notification unit 18 is, for example, a light-emitting device such as an LED that emits light to notify the user of certain information. The notification unit 18 may be a display device such as a liquid crystal display or an organic EL display, capable of displaying information. The notification unit 18 may be an audio output device such as a loudspeaker that notifies the user of information by sound.

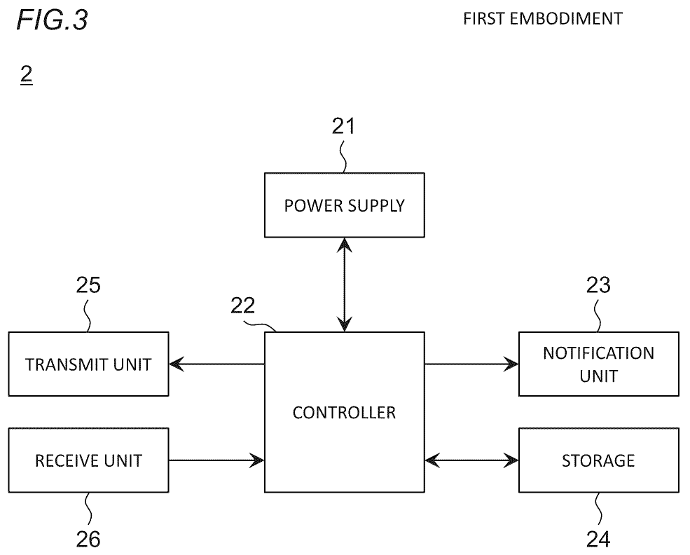

FIG. 3 is a block diagram showing a configuration example of the repeater device 2 of FIG. 1. The repeater device 2 includes a power supply 21, a controller 22, a notification unit 23, a storage 24, a transmit unit 25, and a receive unit 26.

The power supply 21 receives electric power from an electric power source such as a commercial power source or a battery and supplies electric power to the constituent elements of the repeater device 2. The power supply 21 may have a circuit such as a conversion circuit that converts alternating current into direct current.

The controller 22 includes the CPU, the RAM, the ROM, etc., and controls action of the repeater device 2 according to information processing. Such information processing is implemented by executing a program by the controller 22. The controller 22 may be configured from various semiconductor integrated circuits such as the MPU, the GPU, the DSP, the FPGA, and the ASIC, in addition to the CPU.

The storage 24 is the medium that stores recorded information such as a program by electrical, magnetic, optical, mechanical, or chemical action such that the computer or other device, machine, etc., can read the recorded information such as a program. The storage 24 is, for example, the nonvolatile memory capable of retaining memory without power supply, such as the ROM, the flash memory, the hard disk drive, or the solid state drive. The storage 24 stores a program, etc., executed by the controller 22.

The notification unit 23 is the notification device for notifying the user of information indicative of success or failure in transmission/reception of a signal, communication status, etc. The notification unit 23 is, for example, the light-emitting device such as the LED. The notification unit 23 may be the display device such as the liquid crystal display or the organic EL display, capable of displaying information. The notification unit 23 may be the audio output device such as the loudspeaker that notifies the user of information by sound.

The transmit unit 25 includes, for example, an antenna and transmits a repeater signal in accordance with a command of the controller 22. The repeater signal includes the individual identification information. In the case of having received a slave signal including a specific ID, e.g., an ID “A” from the slave device 1, the controller 22 causes the repeater signal to include the ID “A”. As a result, it can be seen that the repeater signal reaching the master device 3 is related to the slave device 1 having the ID “A”.

The receive unit 26 includes, for example, an antenna and receives a slave signal transmitted from the slave device 1 and an ACK signal transmitted from the master device 3.

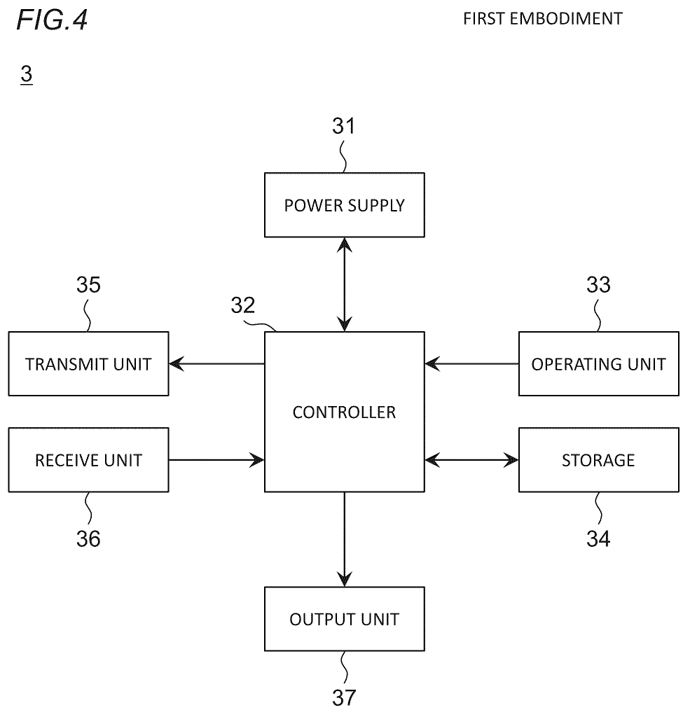

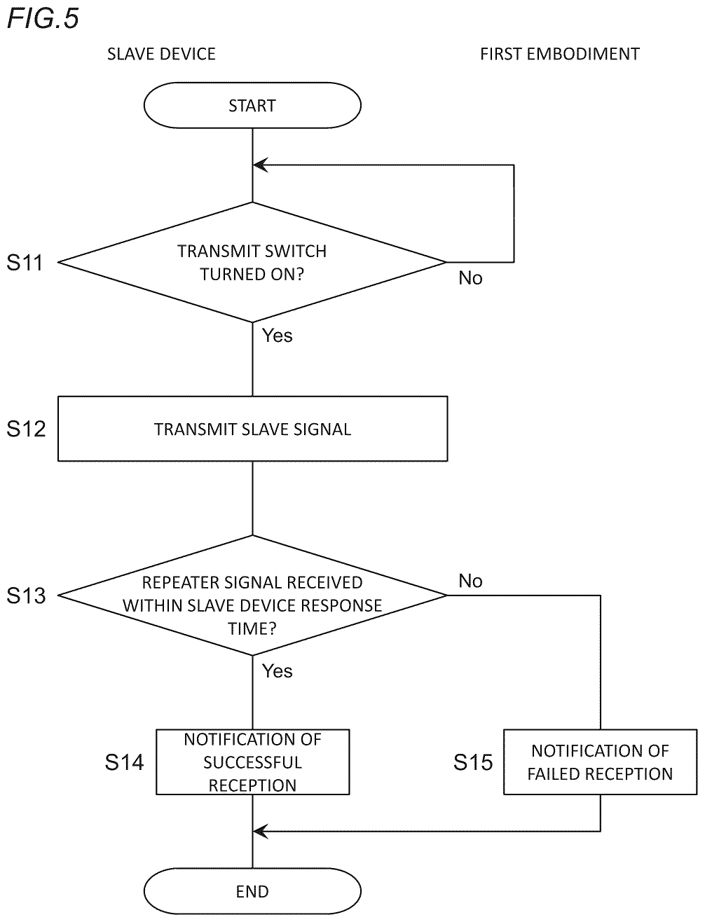

FIG. 4 is a block diagram showing a configuration example of the master device 3 of FIG. 1A to FIG. 1C. The master device 3 includes a power supply 31, a controller 32, an operating unit 33, a storage 34, a transmit unit 35, a receive unit 36, and an output unit 37.

The power supply 31 receives electric power from the electric power source such as the commercial power source or the battery and supplies electric power to the constituent elements of the master device 3. The power supply 31 may have the circuit such as the conversion circuit that converts alternating current into direct current.

The controller 32 includes the CPU, the RAM, the ROM, etc., and controls action of the master device 3 according to information processing. Such information processing is implemented by executing a program by the controller 32. The controller 32 may be configured from various semiconductor integrated circuits such as the MPU, the GPU, the DSP, the FPGA, and the ASIC, in addition to the CPU.

The storage 34 is the medium that stores recorded information such as a program by electrical, magnetic, optical, mechanical, or chemical action such that the computer or other device, machine, etc., can read the recorded information such as a program. The storage 34 is, for example, the nonvolatile memory capable of retaining memory without power supply, such as the ROM, the flash memory, the hard disk drive, or the solid state drive. The storage 34 stores a program, etc., executed by the controller 32.

The operating unit 33 is an input device for inputting information into the controller 32. The operating unit 33 is configured from, e.g., a button, a switch, a touch panel, a pointing such as a mouse, a dial input device, or the like. The user can operate the device to be controlled not only by operating the slave device 1 but also by operating the operating unit 33 of the master device 3.

The transmit unit 35 includes, for example, an antenna and transmits an ACK signal in accordance with a command of the controller 32. The ACK signal includes the individual identification information. In the case of having received a repeater signal including a specific ID, e.g., the ID “A” from the repeater device 2, the controller 32 causes the ACK signal to include the ID “A”. As a result, it can be seen that the ACK signal reaching the repeater device 2 is related to the slave device 1 having the ID “A”.

The receive unit 36 includes, for example, an antenna and receives a repeater signal transmitted from the repeater device 2.

The output unit 37 is an output interface circuit that transmits an output signal to an output destination such as the device to be controlled.

### 1-3. Action Examples

### 1-3-1. Action Example of Slave Device 1

FIG. 5 is a flowchart showing an example of processing executed by the slave device 1 of FIG. 2.

In step S11 of FIG. 5, the controller 14 of the slave device 1 determines whether the transmit switch 11 has been turned on, and if affirmative, goes to step S12, whereas if negative, goes back to step S11. When the button member 110 is pressed by the user so that the transmit switch 11 turns on, electric power is generated by the power generator 12. In step S12, the transmit unit 15 uses the generated electric power to transmit a slave signal to the repeater device 2.

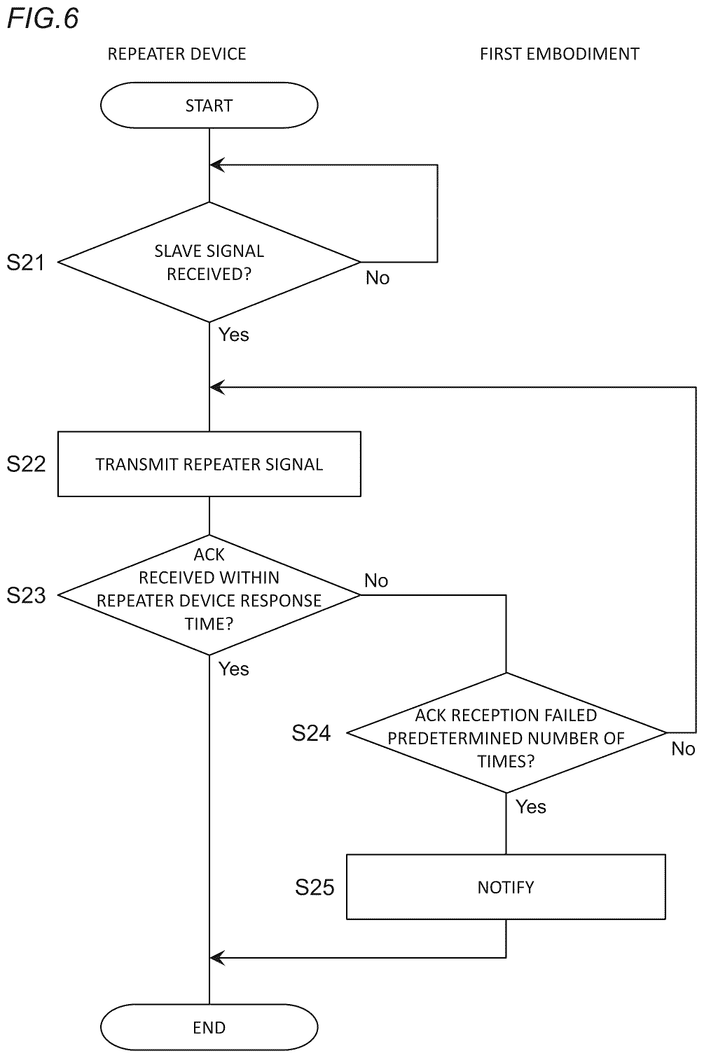

In step S13 of FIG. 5, the controller 14 determines whether the receive unit 16 has received the repeater signal within a predetermined slave device response time from the time of execution of step S12, and if affirmative, goes to step S14, whereas if negative, goes to step S15. This repeater signal is transmitted from the transmit unit 25 of the repeater device 2 in step S22 of FIG. 6 that will be described later. In step S14, the notification unit 18 notifies the user of information indicating that reception has succeeded. For example, in step S14, the notification unit 18 emits green light. In step S15, the notification unit 18 notifies the user of information indicating that reception has failed. For example, in step S15, the notification unit 18 emits red light.

### 1-3-2. Action Example of Relay 2

FIG. 6 is a flowchart showing an example of processing executed by the repeater device 2 of FIG. 3.

In step S21 of FIG. 6, the controller 22 of the repeater device 2 determines whether the receive unit 26 has received the slave signal, and if affirmative, goes to step S22, whereas if negative, goes back to step S21. This slave signal is transmitted from the transmit unit 15 of the slave device 1 in step S12 of FIG. 5.

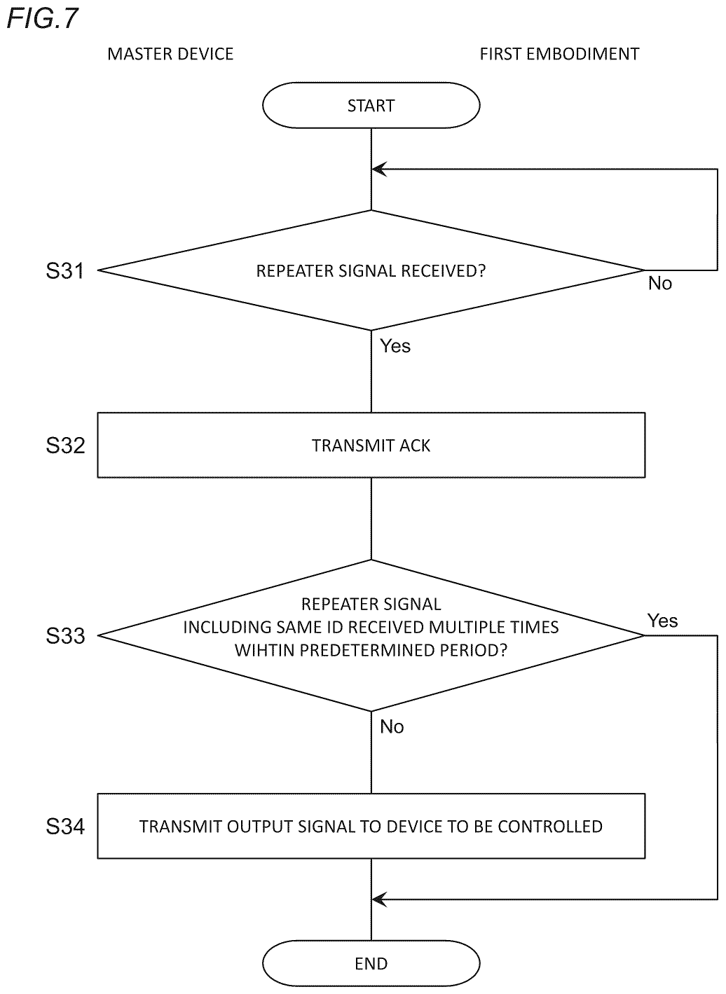

In step S22 of FIG. 6, the transmit unit 25 transmits a repeater signal to the slave device 1 and the master device 3. The transmit unit 25 may transmit the repeater signal to the slave device 1 and the master device 3 at the same time. Alternatively, the transmit unit 25 may transmit a repeater signal to the slave device 1 or the master device 3, and thereafter may transmit a repeater signal to the master device 3 or the slave device 1 within a retransmittable time. In step S23, the controller 22 determines whether the receive unit 26 has received the ACK signal within a predetermined repeater device response time from the time of execution of step S22, and if affirmative, the processing of FIG. 6 comes to an end, whereas if negative, goes to step S24. This ACK signal is transmitted from the transmit unit 35 of the master device 3 in step S32 of FIG. 7 that will be described later.

In step S24 of FIG. 6, the controller 22 determines whether reception of the ACK signal has failed a predetermined number of times, and if affirmative, goes to step S25, whereas if negative, goes back to step S22 to retransmit a repeater signal. Here, failure in reception of the ACK signal means that control advances to No in step S23, i.e., that the controller 22 has determined that receive unit 26 has not received the ACK signal within the predetermined repeater device response time from the time of execution of step S22. For example, in step S24, when the number of times advancing to No in step S23 has reached the predetermined number of times, controller 22 determines that reception of the ACK signal has failed the predetermined number of times, proceeding to step S25.

In the case of advancing to No in step S24 of FIG. 6 to go back to step S22 for retransmission of a repeater signal, it is preferred that retransmission be executed within a predetermined retransmittable time from the time of first transmission of the repeater signal in step S22. The retransmittable time is, e.g., 50 ms (see 3.4.1(3)2 of Non-patent Literature 1 defining ARIB STD-T108). In this case, the repeater device response time of step S23 is set so that retransmission can be executed within the retransmittable time.

In step S25 of FIG. 6, the notification unit 23 notifies the user of information such as a signal indicating that reception of the ACK signal has failed. For example, in the case of being implemented as LED, the notification unit 23 emits light in red. For example, the notification unit 23 may transmit information to a user terminal via a network. This enables the user to know that the repeater device 2 has failed in reception of the ACK signal the predetermined number of times and that the wireless communication system 100 has a problem.

### 1-3-3. Action Example of Master Device 3

FIG. 7 is a flowchart showing an example of processing executed by the master device 3 of FIG. 4.

In step S31 of FIG. 7, the controller 32 of the master device 3 determines whether the receive unit 36 has received the repeater signal, and if affirmative, goes to step S32, whereas if negative, goes back to step S31. This repeater signal is transmitted from the transmit unit 25 of the repeater device 2 in step S22 of FIG. 6. In step S32, the transmit unit 35 transmits an ACK signal to the repeater device 2.

In step S33 of FIG. 7, the controller 32 determines whether a repeater signal including a same ID has been received multiple times within a predetermined period, and if affirmative, processing of FIG. 7 terminates, whereas if negative, goes to step S34. The “predetermined period” is a period from the time before a predetermined time from the current time, to the current time. In step S34, the output unit 37 transmits an output signal to the device to be controlled. The reason why the output signal is not transmitted to the device to be controlled if it has been determined in step S33 that the repeater signal including a same ID has been received multiple times within the predetermined period, is that, in this case, the output signal has already been transmitted to the device to be controlled and therefore that the device to be controlled is being driven.

### 1-3-4. Action Example of Wireless Communication System 100

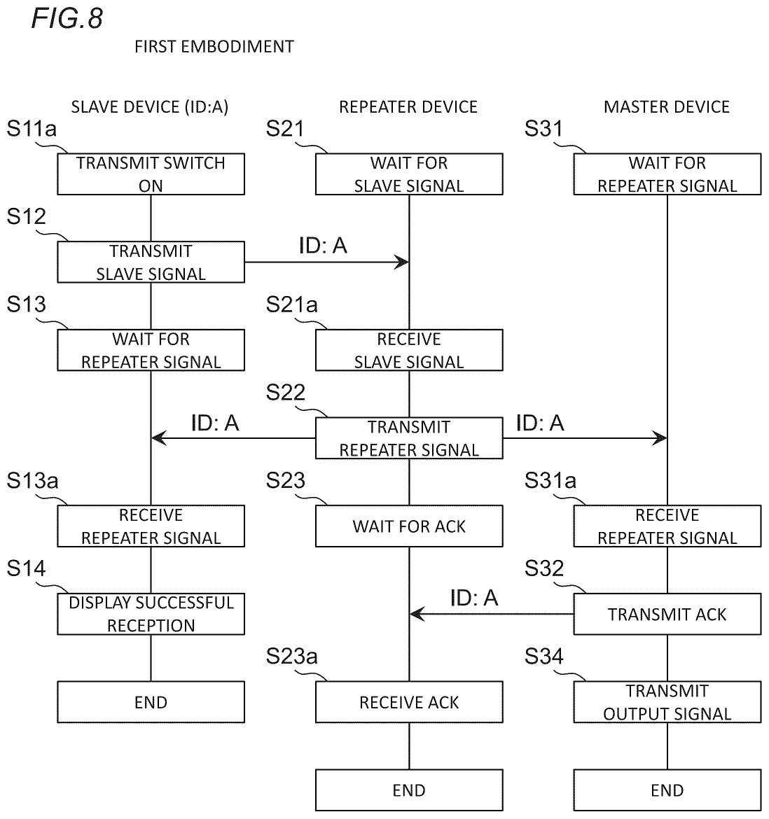

FIG. 8 is a sequence diagram showing an example of overall action of the wireless communication system 100 according to this embodiment. FIG. 8 shows an example where transmissions/receptions of signals between the slave device 1 and the repeater device 2 and between the repeater device 2 and the master device 3 have all succeeded.

In FIG. 8, when the user presses and turns on the transmit switch 11 (S11a), the slave device 1 transmits a slave signal to the repeater device 2 in step S12 (see FIG. 5). Here, the ID of the slave device 1 is expressed by “A”. Accordingly, the slave signal includes individual identification information having the ID “A” of the slave device 1 and the type information for specifying that the transmission source is the slave device 1.

In FIG. 8, the repeater device 2 waiting for a slave signal in step S21 (see FIG. 6) receives the slave signal (S21a) and, in step S22, transmits a repeater signal including the ID “A” to the slave device 1 and the master device 3. The slave device 1 receives the repeater signal (S13a), and step S14 (see FIG. 5), notifies the user of information indicating that reception has succeeded. On the other hand, the master device 3 receives the repeater signal (S31a), and step S32 (see FIG. 7), transmits an ACK signal to the repeater device 2, and further in step S34, transmits an output signal to the device to be controlled. The repeater device 2 receives the ACK signal transmitted from the master device 3 (S23a).

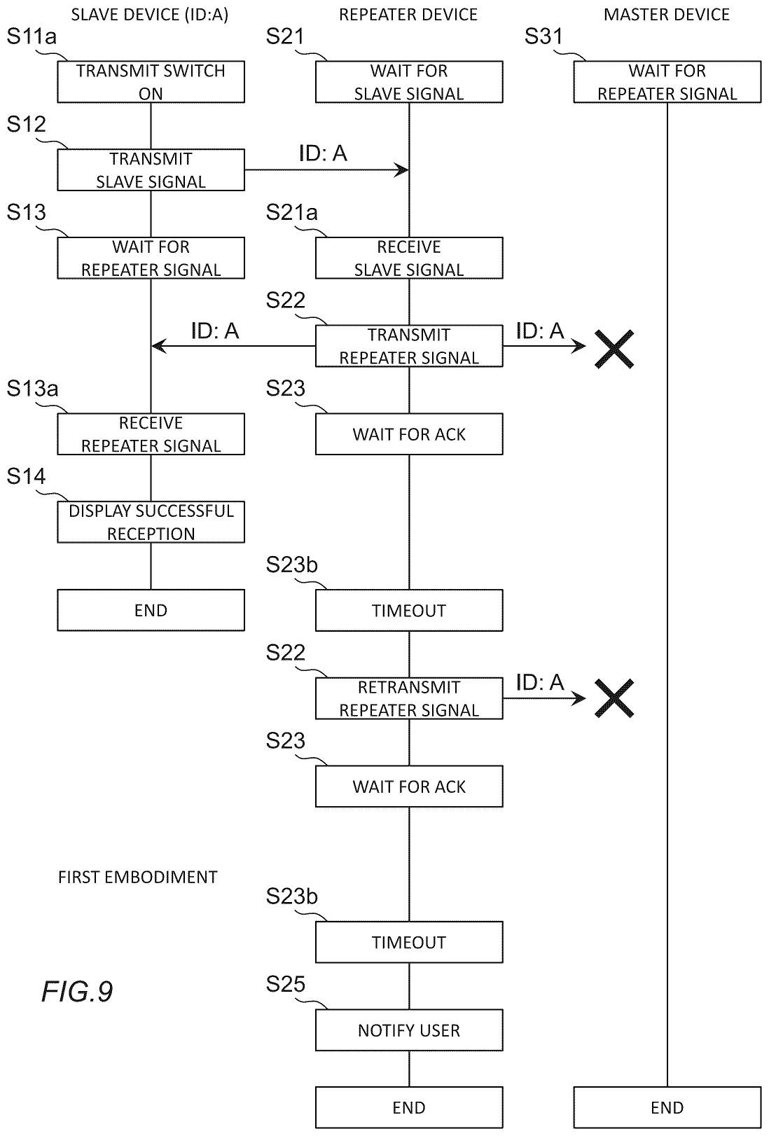

FIG. 9 is a sequence diagram showing another example of overall action of the wireless communication system 100 according to this embodiment. Dissimilar to FIG. 8, FIG. 9 shows the example of failed signal transmission from the repeater device 2 to the master device 3.

In FIG. 9, when the user presses and turns on the transmit switch 11 (S11a), the slave device 1 transmits a slave signal including the ID “A” to the repeater device 2 in step S12 (see FIG. 5). The repeater device 2 waiting for a slave signal in step S21 (see FIG. 6) receives the slave signal (S21a) and, in step S22, transmits a repeater signal including the ID “A” to the slave device 1 and the master device 3. The slave device 1 receives the repeater signal (S13a) and, in step S14 (see FIG. 5), notifies the user of information indicating that reception has succeeded.

In FIG. 9, an example is shown where the repeater signal transmitted from the repeater device 2 has not arrived at the master device 3 due to breakdown of the repeater device 2, breakdown of the master device 3, communication failure, etc. In this case, the master device 3 proceeds to No in step S31 of FIG. 7 and does not execute the ACK signal transmission in step S32. Consequently, the repeater device 2 does not receive an ACK signal within the repeater device response time in step S23 (timeout, S23b), going back to step S22 to retransmit a repeater signal. If the retransmission has also failed and the repeater device 2 does not receive an ACK signal within the repeater device response time in step S23 (timeout, S23b), the repeater device 2 proceeds to notification processing in step S25 when the predetermined number of times in step S24 of FIG. 6 is set to “2”.

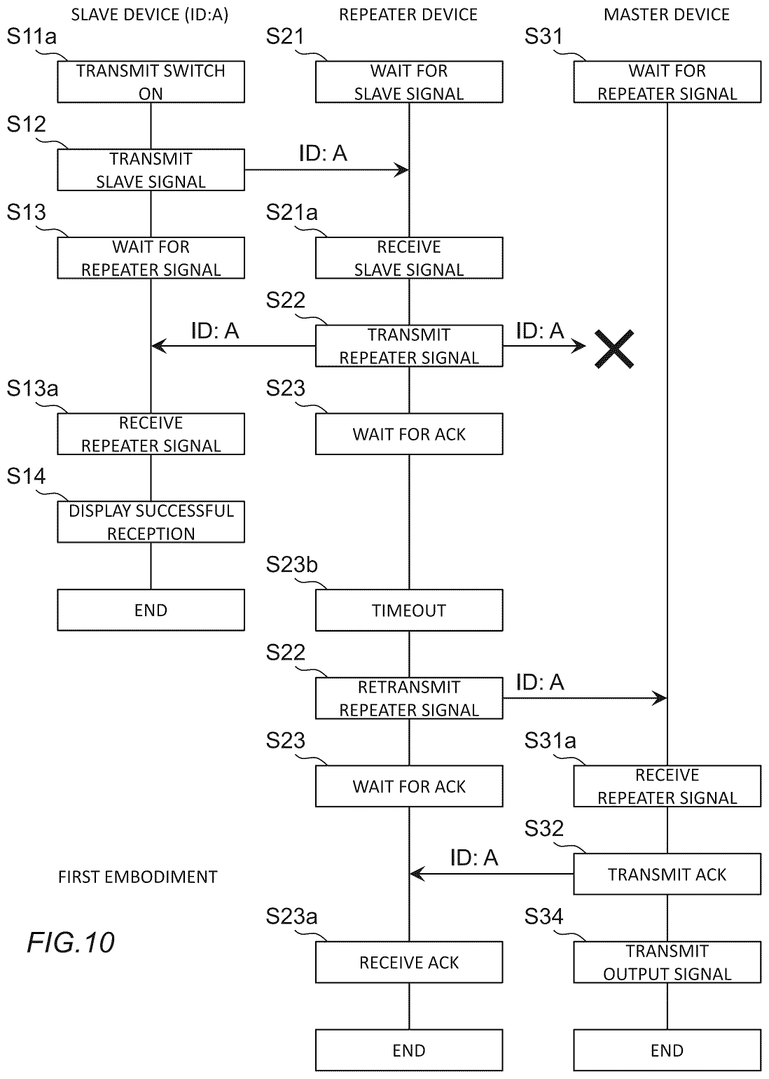

FIG. 10 is a sequence diagram showing yet another example of overall action of the wireless communication system 100 according to this embodiment. Different from FIG. 9, FIG. 10 shows an example where first transmission of the signal from the repeater device 2 to the master device 3 has failed but second transmission has succeeded. In FIG. 10, processing overlapping with that of FIG. 9 will not again be described.

In FIG. 10, the master device 3 succeeds in reception of the repeater signal retransmitted from the repeater device 2 (S31a), transmits an ACK signal to the repeater device 2 in step S32, and further transmits an output signal to the device to be controlled in step S34. The repeater device 2 receives the ACK signal transmitted from the master device 3 (S23a).

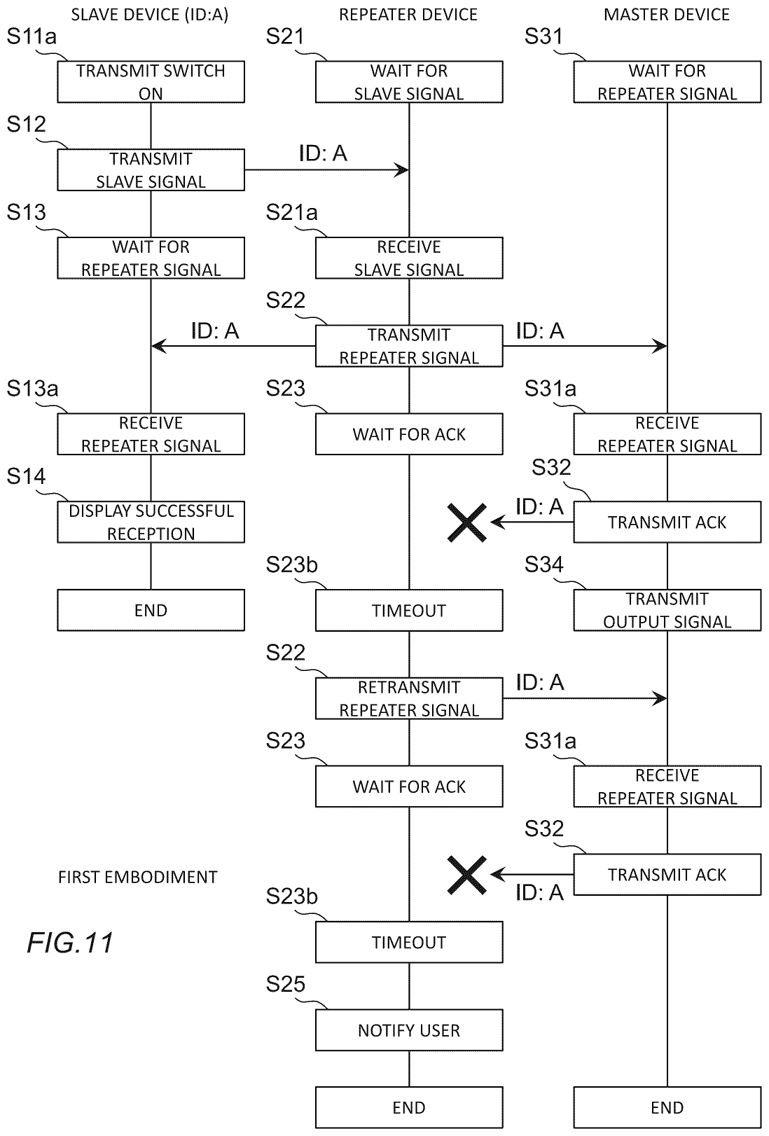

FIG. 11 is a sequence diagram showing still another example of overall action of the wireless communication system 100 according to this embodiment. Unlike FIG. 8, FIG. 11 shows an example where signal transmission from the master device 3 to the repeater device 2 has failed. In FIG. 11, the repeater device 2 does not receive an ACK signal and performs the same action as that of FIG. 9 not receiving the ACK signal.

In FIG. 11, the master device 3 receives the repeater signal including the ID “A” transmitted from the repeater device 2 (S31a), transmits an ACK signal to the repeater device 2 in step S32, and further transmits an output signal to the device to be controlled in step S34. However, because of breakdown of the repeater device 2, breakdown of the master device 3, communication failure, etc., the repeater device 2 does not receive the ACK signal within the repeater device response time in step S23 (timeout, S23b), going back to step S22 to retransmit a repeater signal.

The master device 3 receives the repeater signal including the ID “A” retransmitted from the repeater device 2 (S31a) and transmits an ACK signal to the repeater device 2 in step S32. Since the master device 3 has received the repeater signal including the same ID multiple times within the predetermined period, the master device 3 advances to Yes of step S33, this time not executing step S34 of transmitting the output signal to the device to be controlled.

In FIG. 11, since second transmission of the ACK signal by the master device 3 has also failed and the repeater device 2 does not receive the ACK signal within the repeater device response time in step S23 (timeout, S23b), when the predetermined number of times in step S24 of FIG. 6 is set to “2”, the repeater device 2 goes to notification processing in step S25.

### 1-4. Effects, Etc.

As above, the repeater device 2 according to this embodiment includes the receive unit 26 that receives a slave signal transmitted wirelessly from the slave device 1, and the transmit unit 25. The transmit unit 35 transmits a repeater signal wirelessly to the slave device 1 and the master device 3, based on the slave signal. The receive unit 26 further receives an ACK signal corresponding to the repeater signal, transmitted wirelessly from the master device 3. The repeater device 2 according to this embodiment is characterized in that the repeater signal is transmitted also to the slave device 1.

According to this configuration, instead of transmitting a repeater signal to the slave device 1 in response to reply of an ACK signal from the master device 3 after transmission of a repeater signal to the master device 3, the repeater device 2 can simultaneously perform transmission of the repeater signal to the master device 3 and transmission of the repeater signal to the slave device 1. Hence, the procedure of transmission of the repeater signal can be simplified as compared with the prior art. Also, according to the repeater device 2 of this embodiment, there is no need to dispose the transmission downtime defined in the communication standards such as ARIB STD-T108, between transmission of the repeater signal to the master device 3 and transmission of the repeater signal to the slave device 1, enabling to reduce the time from when the slave device 1 transmits the slave signal to the repeater device 2 to when it receives the repeater signal, as compared with the prior art.

When the receive unit 26 does not receive an ACK signal within a predetermined first response time from the time of transmission of a repeater signal by the transmit unit 25, the transmit unit 25 may retransmit a repeater signal to the master device 3 once or multiple times.

According to this configuration, opportunities of successfully communicating with the master device 3 can be increased as compared with the case not retransmitting the repeater signal.

The transmit unit 25 may retransmit a repeater signal to the master device 3 within a predetermined retransmittable time from the time of transmission of a repeater signal by the transmit unit 25. The retransmittable time is, for example, 50 milliseconds.

According to this configuration, the repeater device 2 complying with communication standards such as ARIB STD-T108 is obtained by adhering to the retransmittable time.

The repeater device 2 may further include the notification unit 23. The notification unit 23 notifies the user of information when the receive unit 26 does not receive an ACK signal within the predetermined first response time from last transmission of a repeater signal by the transmit unit 25.

According to this configuration, the user can know that the repeater device 2 has failed to receive the ACK signal and know that there may be a problem with communication between the repeater device 2 and the master device 3.

The slave device 1 includes the transmit unit 15 that transmits a slave signal wirelessly to the repeater device 2, the receive unit 16 that receives a repeater signal transmitted wirelessly from the repeater device 2, and the notification unit 18 for notifying the user of information. When the receive unit 16 has received a repeater signal within a predetermined second response time from the time of transmission of a slave signal by the transmit unit 15, the notification unit 18 notifies the user of information indicating that reception has succeeded.

According to this configuration, there can be obtained the slave device 1 applicable to the wireless communication system 100 capable of reducing the time from when the slave device 1 transmits the slave signal to the repeater device 2 to when it receives the repeater signal as described above. By the notification unit 18, the user using the slave device 1 can know success/failure in operation performed using the slave device 1 and in communication between the slave device 1 and the repeater device 2.

The slave device 1 may further include the transmit switch 11 and the power generator 12. The transmit switch 11 has the button member 110 and performs switching between on-state and off-state by movement of the button member 110. The power generator 12 generates electric power by using energy generated with movement of the button member 110. The transmit unit 15 uses electric power generated by the power generator 12, to transmit a slave signal to the repeater device 2.

According to this configuration, the slave device 1 can transmit the slave signal without using a primary battery or a secondary battery, eliminating the necessity for battery replacement and charging. Using the generated electric power, such the self-powered slave device 1 can more reliably transmit the slave signal and more reliably grasp the state of reception of the repeater signal.

The slave device 1 may further include the power accumulator 13 that accumulates electric power generated by the power generator 12. The receive unit 16 receives a repeater signal by the electric power supplied from the power accumulator 13, and the notification unit 18 notifies of information by the electric power supplied from the power accumulator 13.

According to this configuration, even after transmitting a slave signal, the slave device 1 can receive a repeater signal and notify information by the notification unit 18, by using electric power accumulated by the power accumulator 13.

The master device 3 includes the master device receive unit 36 that receives a repeater signal transmitted wirelessly from the repeater device 2, the transmit unit 35 that transmits an ACK signal to the repeater device 2 when the receive unit 36 receives a repeater signal, and the output unit 37 that outputs a control signal to the device to be controlled when the receive unit 36 receives a repeater signal.

According to this configuration, there can be obtained the master device 3 applicable to the wireless communication system 100 capable of reducing time from when the slave device 1 transmits the slave signal to the repeater device 2 to when it receives the repeater signal as described above.

### 2. Second Embodiment

### 2-1. Knowledge on Bidirectional Wireless Communication System

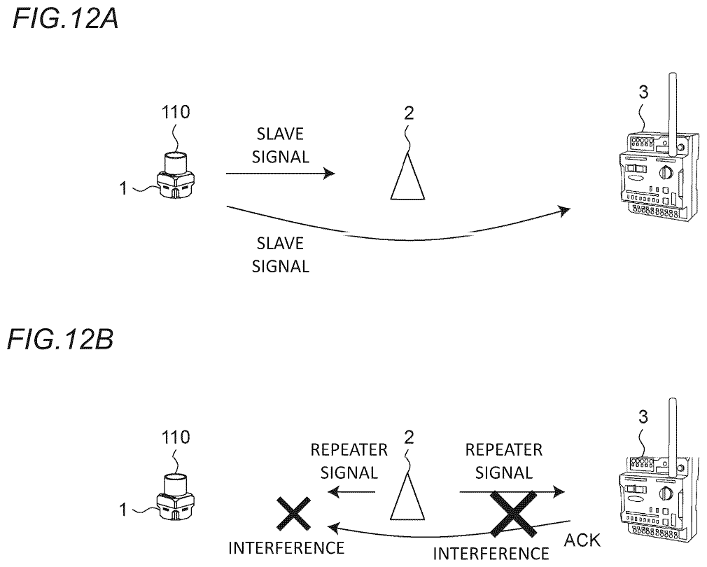

In the wireless communication system performing bidirectional wireless communication between the slave device 1 and the master device 3 by way of the repeater device 2, when the master device 3 and the repeater device 2 lie in a proximity space, the slave signal may reach not only the repeater device 2 but also the master device 3 as shown in FIG. 12A In this case, as shown in FIG. 12B the repeater device 2 transmits a repeater signal to the slave device 1 and the master device 3 in response to the slave signal, while the master device 3 transmits an ACK signal to the slave device 1 in response to the slave signal, and hence the repeater signal and the ACK signal may interfere with each other. When interference occurs, the slave device 1 may fail in reception of the repeater signal or the ACK signal and notify the user of information indicative of failed reception (see step S15 of FIG. 5), or the repeater device 2 may determine that communication with the master device 3 has failed and retransmit the repeater signal. This has a problem in that reception failure notification by the slave device 1 and retransmission processing by the repeater device 2 are performed despite the fact that the master device 3 has received the slave signal and transmitted the output signal to the device to be controlled (see step S34 of FIG. 7). The wireless communication system 100 according to a second embodiment of the present disclosure solves this problem.

### 2-2. Action Example

### 2-2-1. Action Example of Slave Device 1

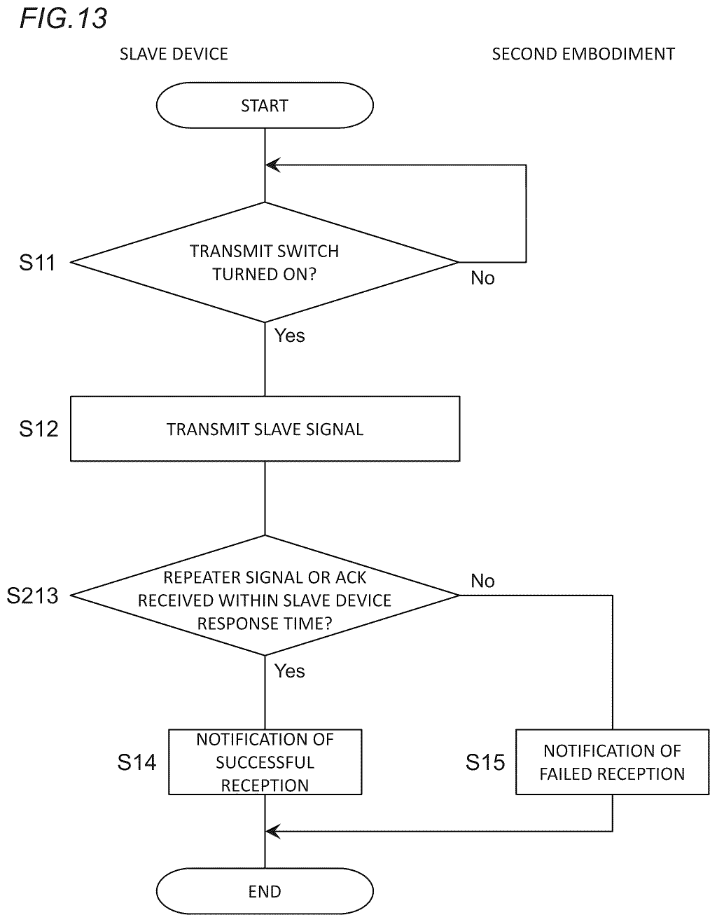

FIG. 13 is a flowchart showing an example of processing executed by the slave device 1 of the wireless communication system 100 according to this embodiment. The flowchart of FIG. 13 includes step S213, in place of step S13 of FIG. 5. Different from step S13 of FIG. 5 waiting for only the repeater signal, step S213 of FIG. 13 is a step of waiting for both the repeater signal and the ACK signal. Hence, as compared with the first embodiment, the receive unit 16 of the slave device 1 receives not only the repeater signal transmitted from the repeater device 2 but also the ACK signal transmitted from the master device 3. In step S13 of FIG. 13, the controller 14 of the slave device 1 determines whether the receive unit 16 has received the repeater signal or the ACK signal within a predetermined slave device response time from the time of execution of step S12, and if affirmative, goes to step S14, whereas if negative, goes to step S15.

### 2-2-2. Action Example of Master Device 3

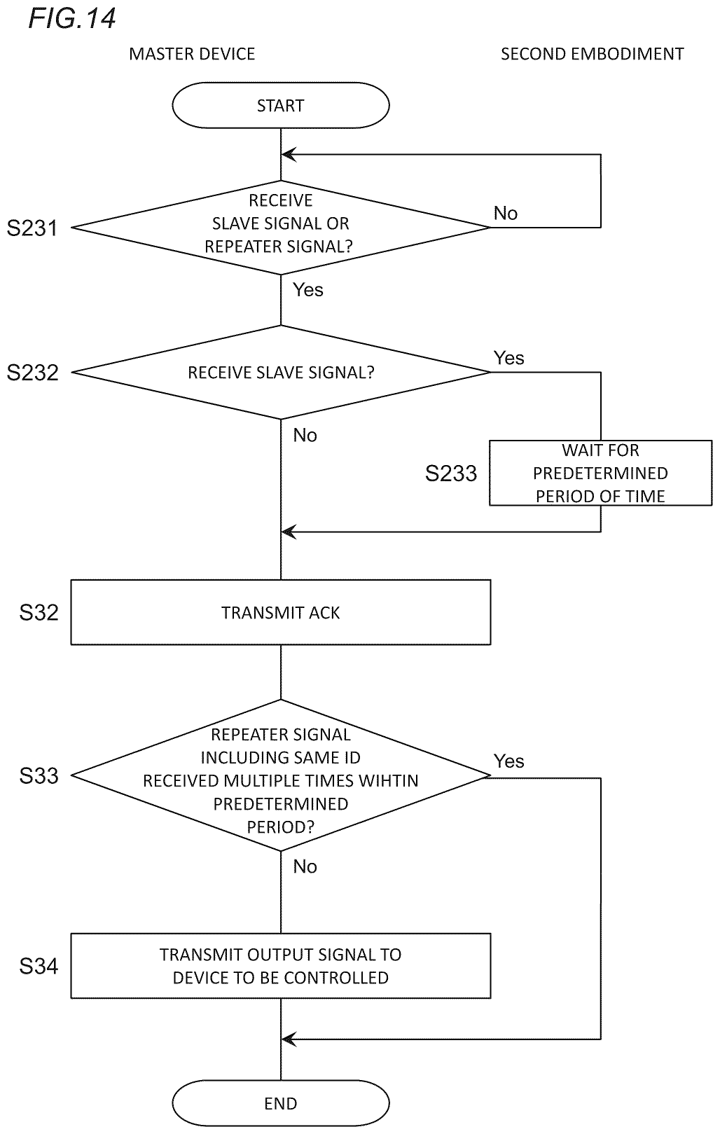

FIG. 14 is a flowchart showing an example of processing executed by the master device 3 of the wireless communication system 100 according to this embodiment.

As compared with the first embodiment, the receive unit 36 of the master device 3 receives not only the repeater signal transmitted from the repeater device 2 but also the slave signal transmitted from the slave device 1. In step S231 of FIG. 14, the controller 32 of the master device 3 determines whether the receive unit 36 has received the slave signal or the repeater signal, and if affirmative, goes to step S232, whereas if negative, goes back to step S231.

In step S232 of FIG. 14, the controller 32 determines whether the signal received by the receive unit 36 is a slave signal, and if affirmative, goes to step S233, whereas if negative, goes to step S32. In step S233, the controller 32 waits for a predetermined wait time, and proceeds to step S32. Subsequent steps S32 to S34 are the same as those of FIG. 7 and therefore will not again be described.

That is, in the flow of FIG. 14, when the master device 3 receives a repeater signal at the signal wait step S231, the master device 3 immediately transmits an ACK signal to the repeater device 2, similar to the first embodiment shown in FIG. 7. On the other hand, in the flow of FIG. 14, when the master device 3 receives a slave signal at the signal wait step S231, the master device 3 transmits an ACK signal to the slave device 1 after waiting for a wait time T.

The wait time T to wait at the waiting step S233 is longer than a time from the repeater device 2 receives the slave signal to when it completes transmitting the repeater signal. That is, the wait time T is set so as to satisfy Formula (1) which follows.

T>t1+t2 (1)

where t1 is a time from when the repeater device 2 receives the slave signal to when it completes transmitting the repeater signal. t2 is a temporal length of the repeater signal itself and is a time from the start of transmission of the repeater signal by the repeater device 2 to the completion of transmission.

The wait time T is set so that the slave device 1 can receive an ACK signal from the master device 3 before electric power generated by the self-powered slave device 1 runs out. For example, the wait time T is shorter than the power suppliable time during which the power accumulator 13 can supply electricity. The wait time T is, for example, several ms.

### 2-2-3. Action Example of Wireless Communication System 100

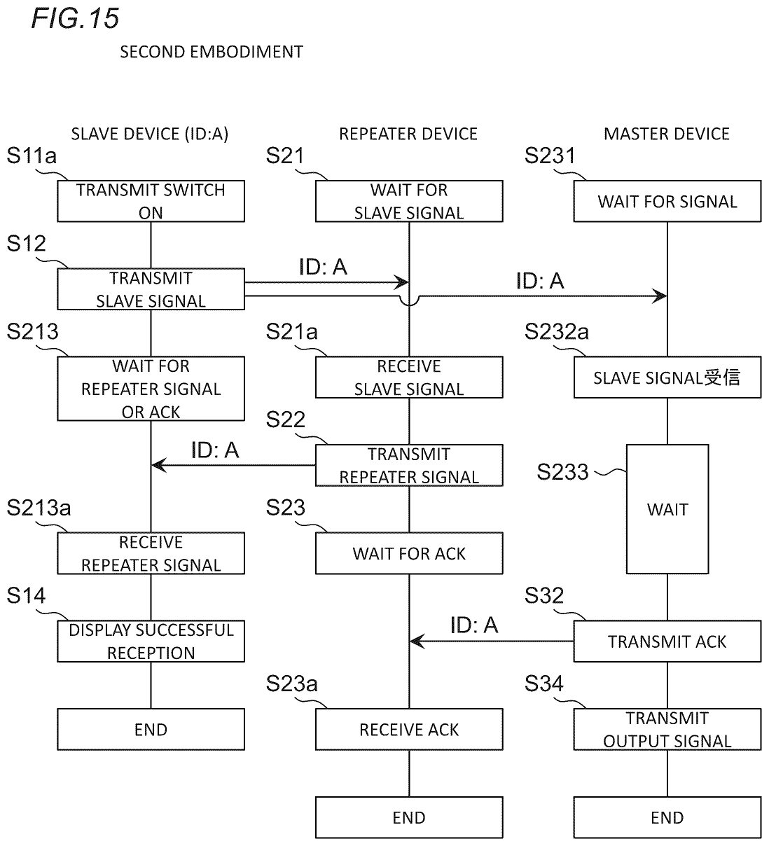

FIG. 15 is a sequence diagram showing an example of overall action of the wireless communication system 100 according to this embodiment.

In FIG. 15, when the user presses and turns on the transmit switch 11 (S11a), the slave device 1 transmits a slave signal to the repeater device 2 and the master device 3 in step S12 (see FIG. 13). Here, the ID of the slave device 1 is expressed by “A”. Thus, the slave signal includes individual identification information having the ID “A” of the slave device 1 and the type information for specifying that the transmission source is the slave device 1.

In FIG. 15, the repeater device 2 waiting for a slave signal in step S21 (see FIG. 6) receives a slave signal (S21a) and, in step S22, transmits a repeater signal including the ID “A” to the slave device 1. The slave device 1 receives the repeater signal (S213a) and, in step S14 (see FIG. 13), notifies the user of information indicating that reception has succeeded.

On the other hand, the master device 3 receives the slave signal (S232a) and therefore waits for the wait time T at the waiting step S233. Next, in step S32 (see FIG. 7), the master device 3 transmits an ACK signal to the repeater device 2 and further, in step S34, transmits an output signal to the device to be controlled. The repeater device 2 receives the ACK signal transmitted from the master device 3 (S23a).

As above, the master device 3 according to this embodiment receives the signal directly or via the repeater device 2 from the slave device 1. When receiving the slave signal from the slave device 1, the repeater device 2 transmits a repeater signal wirelessly to the slave device 1 and the master device 3. The master device 3 includes the receive unit 36, the transmit unit 35, and the output unit 37. The receive unit 36 receives a slave signal and a repeater signal. When the receive unit 36 receives a repeater signal, the transmit unit 35 transmits an ACK signal to the slave device 1 and the repeater device 2. The output unit 37 outputs a control signal to the device to be controlled when the receive unit 36 receives at least one of the slave signal and the repeater signal. When the receive unit 36 receives the slave signal, the transmit unit 35 transmits an ACK signal to the slave device 1 and the repeater device 2 after the predetermined wait time T.

According to this configuration, when a slave signal reaches both the repeater device 2 and the master device 3, the repeater device 2 transmits a repeater signal to the slave device 1 and the master device 3 instantly in response to the slave signal, whereas the master device 3 transmits an ACK signal to the slave device 1 and the repeater device 2 after the predetermined wait time T, with the result that the repeater signal and the ACK signal are transmitted at a time interval. In consequence, there occurs no problem of interference between the repeater signal and the ACK signal.

The wait time T may be longer than a time from when the repeater device 2 receives the slave signal to when it completes transmitting the repeater signal.

This configuration can also achieve the effect of no interference between the repeater signal and the ACK signal, similar to the above.

The slave device 1 includes the transmit unit 15 that transmits a slave signal wirelessly to the repeater device 2, the receive unit 16 that receives a repeater signal and an ACK signal, and the notification unit 18 for notifying the user of information. When the receive unit 16 receives at least one of the repeater signal and the ACK signal within a predetermined response time from the time of transmission of the slave signal by the transmit unit 15, the notification unit 18 notifies the user of information indicating that reception has succeeded.

According to this configuration, there can be obtained the slave device 1 applicable to the wireless communication system 100 that achieves the effect of no interference between the repeater signal and the ACK signal as above. The user using the slave device 1 can know, by the notification unit 18, success/failure in: operation performed using the slave device 1; communication between the slave device 1 and the repeater device 2; and communication between the slave device 1 and the master device 3.

The repeater device 2 includes the receive unit 26 and the transmit unit 25. The receive unit 26 receives a slave signal transmitted wirelessly from the slave device 1 and an ACK signal transmitted wirelessly from the master device 3. Based on the received slave signal, the transmit unit 25 transmits a repeater signal wirelessly to the slave device 1 and the master device 3.

According to this configuration, there can be obtained the repeater device 2 applicable to the wireless communication system 100 that achieves the effect of no interference between the repeater signal and the ACK signal as above.

In the wireless communication system 100, the slave device 1 may further include the transmit switch 11 and the power generator 12. The transmit switch 11 has the button member 110 and performs on-off switching by movement of the button member 110. The power generator 12 generates electric power by using energy generated with movement of the button member 110. The transmit unit 15 uses electric power generated by the power generator 12, to transmit a slave signal to at least one of the repeater device 2 and the master device 3.

According to this configuration, the slave device 1 can transmit the slave signal without using a primary battery or a secondary battery, eliminating the need for battery replacement and charging. Using the generated electric power, such the self-powered slave device 1 can more reliably transmit the slave signal and more reliably grasp the state of reception of the repeater signal.

In the wireless communication system 100, the slave device 1 may further include the power accumulator 13 that accumulates electric power generated by the power generator 12. The receive unit 16 receives at least one of the repeater signal and the ACK signal by electric power supplied from the power accumulator 13, and the notification unit 18 notifies of information by electric power supplied from the power accumulator 13.

According to this configuration, even after transmitting the slave signal, the slave device 1 can perform reception of at least one of the repeater signal and the ACK signal and notification of information by the notification unit 18, by using electric power accumulated by the power accumulator 13.

The wait time T may be shorter than the power suppliable time during which the power accumulator 13 can supply electricity.

According to this configuration, the slave device 1 can perform reception of at least one of the repeater signal and the ACK signal and notification of information by the notification unit 18, by using electric power accumulated by the power accumulator 13.

### 3. Third Embodiment

### 3-1. Application Example

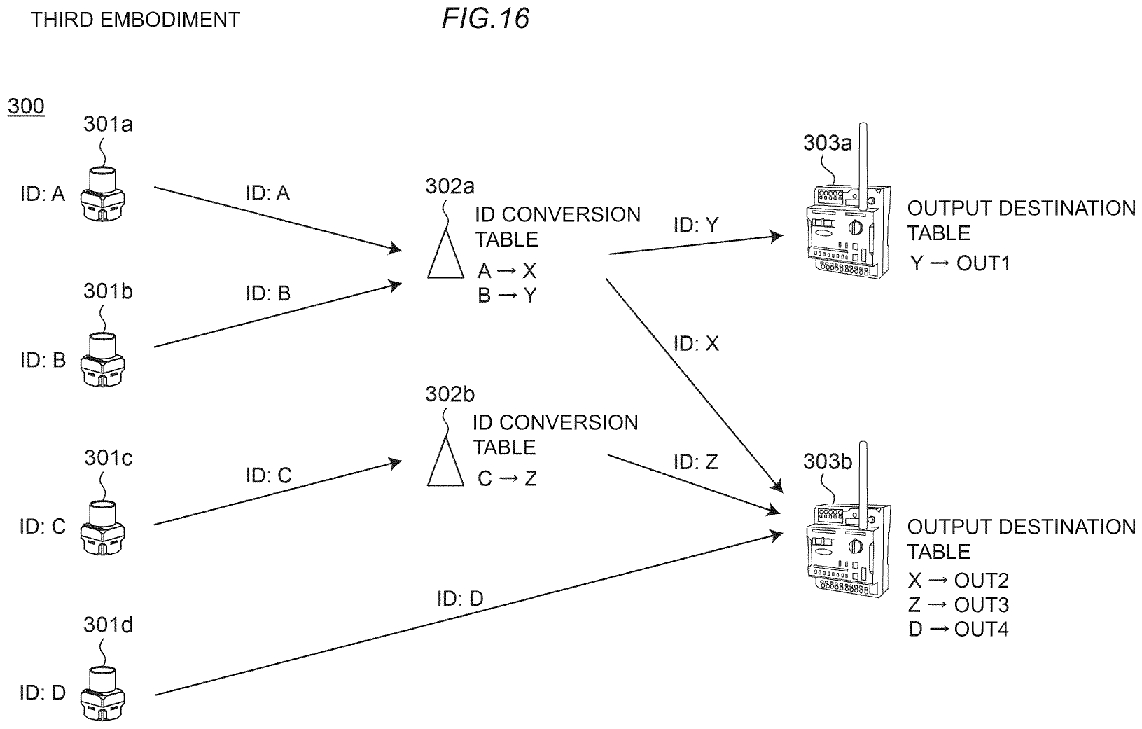

FIG. 16 is a diagram showing an application example of a wireless communication system 300 according to a third embodiment of the present disclosure. The wireless communication system 300 includes a plurality of slave devices 301, one or more repeater devices 302, and one or more master devices 303. FIG. 16 exemplifies four slave devices 301a, 301b, 301c, and 301d, two repeater devices 302a and 302b, and two master devices 303a and 303b.

In FIG. 16, the slave device 301a transmits a slave signal including an ID “A” to the repeater device 302a in response to the user's operation. Similarly, the slave device 301b transmits a slave signal including an ID “B” to the repeater device 302a, while the slave device 301c transmits a slave signal including an ID “C” to the repeater device 302b. The repeater device 302a converts the conversion target IDs “A” and “B” into converted IDs “X” and “Y”, respectively, based on an ID conversion table stored in advance. The repeater device 302b converts the conversion target ID “C” into a converted ID “Z”, based on the ID conversion table stored in advance.

The repeater device 302a transmits a repeater signal including the converted ID “X” to the slave device 301a and the master device 303b when receiving the slave signal including the ID “A” and transmits a repeater signal including the converted ID “Y” to the slave device 301b and the master device 303a when receiving the slave signal including the ID “B”.

The slave device 301d transmits a slave signal including an ID “D” directly to the master device 303b.

The master devices 303a and 303b store an output destination table that correlates master device target IDs with control signal output destinations, to select an output destination, based on the ID included in the received signal. In the example of FIG. 16, when receiving a repeater signal including the ID “Y”, the master device 303a returns an ACK signal including the ID “Y” to the repeater device 302a and transmits a control signal to an output destination OUT1. When receiving a repeater signal including the ID “X”, the master device 303b returns an ACK signal including the ID “X” to the repeater device 302a and transmits a control signal to an output destination OUT2. When receiving a repeater signal including the ID “Z”, the master device 303b returns an ACK signal including the ID “Z” to the repeater device 302b and transmits a control signal to an output destination OUT3.

When receiving a slave signal including an ID “D”, the master device 303b returns an ACK signal including the ID “D” to the slave device 301d and transmits a control signal to an output destination OUT4.

Thus, the slave devices 301a to 301d are linked with the output destinations OUT1 to OUT4, respectively. In the wireless communication system 300, the ID conversion table and the output destination table are shared and adjusted to prevent malfunction. For example, since the master device target IDs of the output destination table do not include the IDs “A”, “B”, and “C”, the master devices 303a and 303b do not return an ACK signal in direct response to slave signals transmitted from the slave devices 301a to 301c. Since the conversion target IDs of the ID conversion table do not include the ID “D”, the repeater devices 302a and 302b do not return a repeater signal in response to a transmission signal transmitted from the slave device 301d.

Thus, according to the wireless communication system 300, even though a slave signal including the ID “A” has reached both the repeater device 302a and the master device 303a, the master device 303a do not return an ACK signal in response to the slave signal, so that there occurs no problem of interference between the repeater signal from the repeater device 302a and the ACK signal from the master device 303a.

As above, similar to the second embodiment, the wireless communication system 300 according to this embodiment solves the problem of interference between the repeater signal and the ACK signal.

### 3-2. Configuration Example

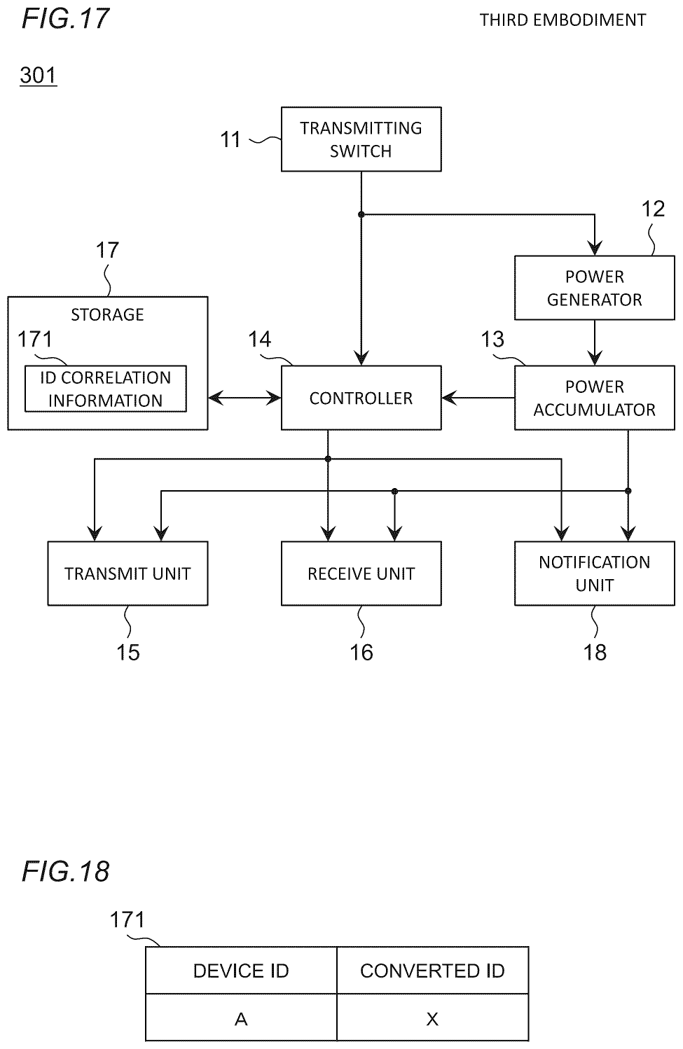

FIG. 17 is a block diagram showing a configuration example of the slave device 301 according to this embodiment. As compared with the slave device 1 of FIG. 2, in FIG. 17, the storage 17 of the slave device 301 stores ID correlation information 171 in advance.

FIG. 18 is a table showing an example of the ID correlation information 171 of FIG. 17. In the ID correlation information 171, an own device ID and a converted ID are previously correlated with each other. FIG. 18 shows an example where the device ID of slave device 1 is “A”, with the converted ID of “X”. As will be described later, the ID “A” indicative of the slave device 1 is converted into an ID “X” by an ID converter 221 of the repeater device 302.

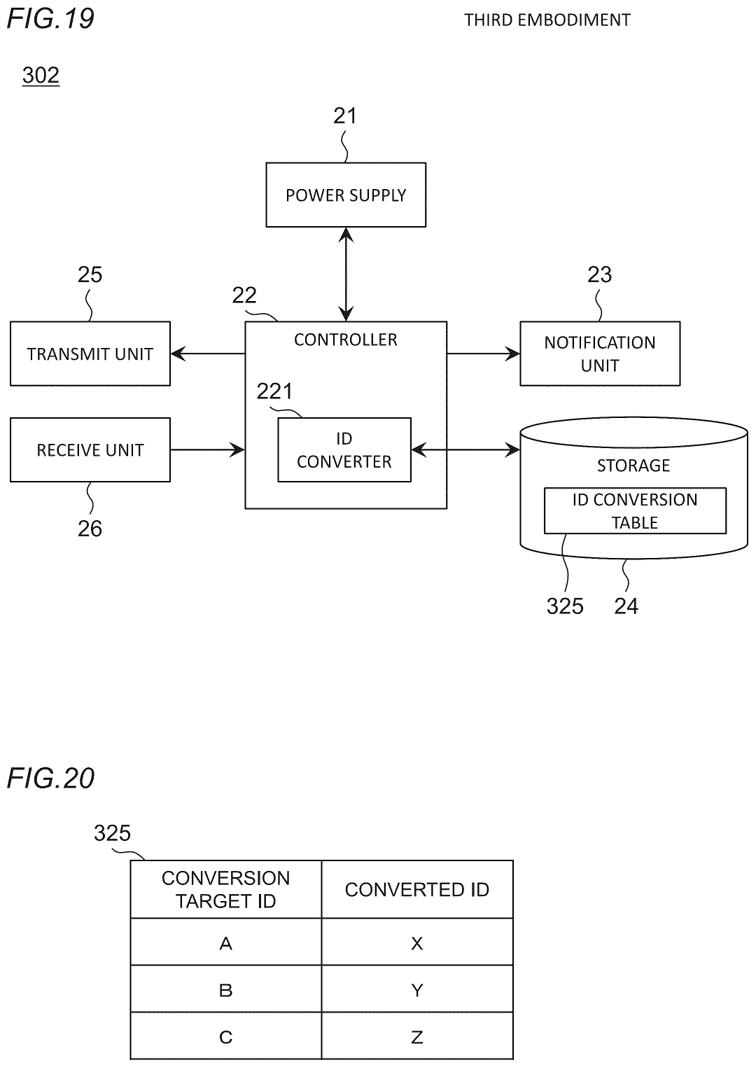

FIG. 19 is a block diagram showing a configuration example of the repeater device 302 according to this embodiment. As compared with the repeater device 2 of FIG. 3, in FIG. 19, the controller 22 includes the ID converter 221, and the storage 24 stores an ID conversion table 325 in advance. The ID converter 221 is an example of “individual identification information converter” of the present disclosure, while the ID conversion table 325 is an example of “conversion table” of the present disclosure.

FIG. 20 is a table showing an example of the ID conversion table 325 of FIG. 19. In the ID conversion table 325, a plurality of conversion target IDs and converted IDs are correlated in advance. In the example of FIG. 20, the conversion target IDs “A”, “B” and “C” are correlated with the converted IDs “X”, “Y”, and “Z”, respectively.

When a slave device ID included in a slave signal coincides with one of a plurality of conversion target IDs of the ID conversion table 325, the ID converter 221 of FIG. 19 refers to the ID conversion table 325 to convert the slave device ID into a converted ID. The ID converter 221 may generate a repeater signal that includes a converted ID corresponding to one of the plurality of conversion target IDs in the ID conversion table 325. In the example where the ID conversion table 325 of FIG. 20 is stored in the storage 24, when receiving a slave signal including the ID “A”, the ID converter 221 converts the ID “A” into the ID “X”.

The relationship between the conversion target IDs and the converted IDs in the ID conversion table 325 of FIG. 20 corresponds to the relationship (see FIG. 18) between the device ID and the converted ID in the ID correlation information 171 included in each of the plurality of slave devices of the wireless communication system 300. In the examples shown in FIGS. 18 and 20, the device ID in the ID correlation information 171 of FIG. 18 is “A” with the converted ID of “X”, whereas the converted ID corresponding to the conversion target ID “A” is “X”, with the result that the relationships of the two coincide consistently.

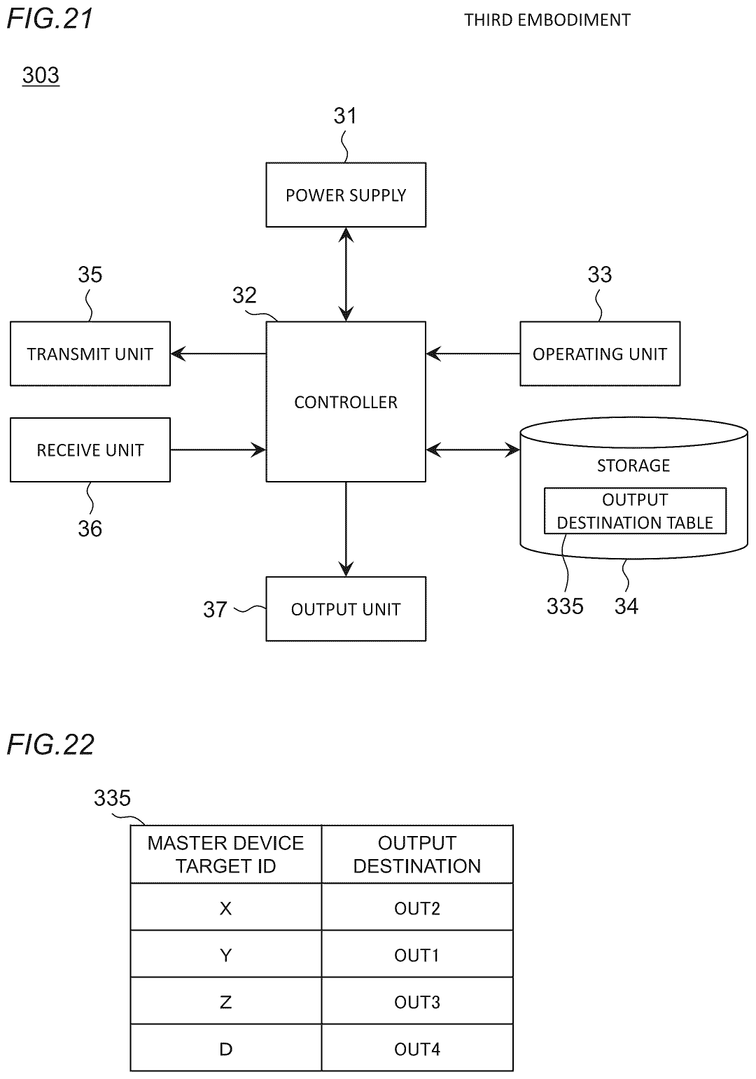

FIG. 21 is a block diagram showing a configuration example of the master device 303 according to this embodiment. As compared with the master device 3 of FIG. 4, in FIG. 21, an output destination table 335 is previously stored in the storage 34 of the master device 303.

FIG. 22 is a table showing an example of the output destination table 335 of FIG. 21. In the output destination table 335, a plurality of master device target IDs and output destination information are correlated in advance. In the example of FIG. 22, the master device target IDs “X”, “Y”, “Z”, and “D” are correlated with the output destinations “OUT2”, “OUT1”, “OUT3”, and “OUT4”, respectively. The output destinations OUT1 to OUT4 are each linked with a corresponding device to be controlled.

### 3-3. Action Example

### 3-3-1. Action Example of Slave Device 1

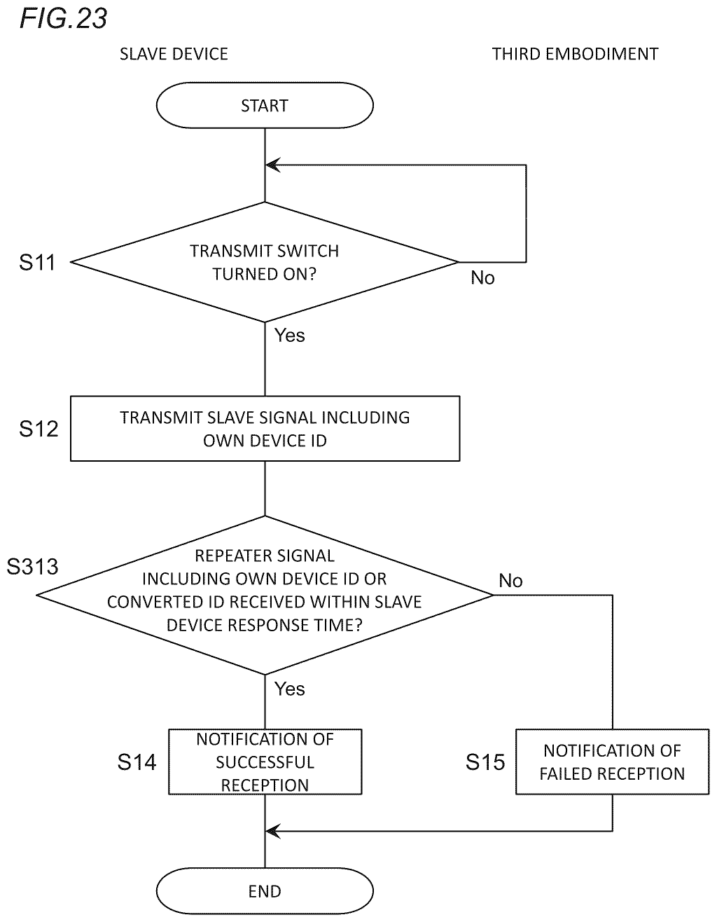

FIG. 23 is a flowchart showing an example of processing executed by the slave device 301 of FIG. 17. As compared with FIG. 5, processing of FIG. 23 includes a step S313 in lieu of step S13. In step S313 of FIG. 23, the controller 14 determines whether the receive unit 16 has received a repeater signal including the device ID or the converted ID within a predetermined slave device response time from the time of execution in step S12, and if affirmative, goes to step S14, whereas if negative, goes to step S15. The controller 14 refers to the ID correlation information 171 of FIG. 17 to determine whether the receive unit 16 has received a repeater signal including the device ID or the converted ID.

### 3-3-2. Action Example of Relay 2

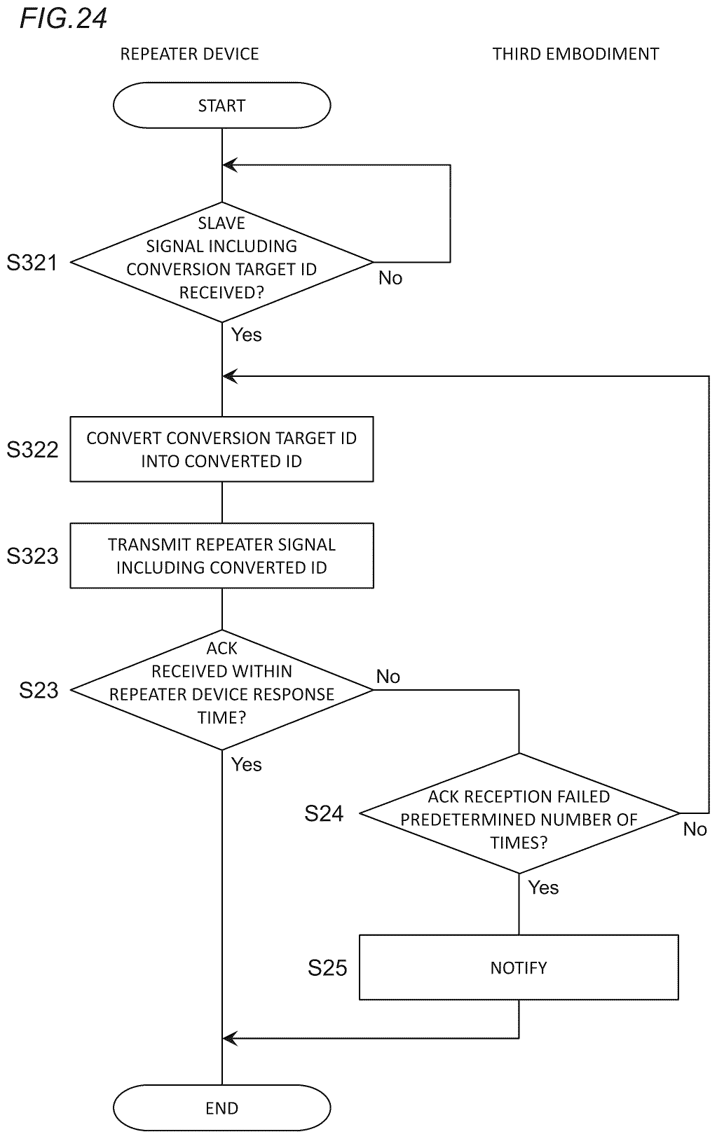

FIG. 24 is a flowchart showing an example of processing executed by the repeater device 302 of FIG. 19.

In step S321 of FIG. 24, the controller 22 of the repeater device 302 determines whether the receive unit 26 has received a slave signal including a conversion target ID, and if affirmative, goes to step S322, whereas if negative, goes back to step S321. The controller 22 refers to the ID conversion table 325 of FIG. 20, to determine whether the receive unit 36 has received a slave signal including a conversion target ID.

In step S322 of FIG. 24, the ID converter 221 refers to the ID conversion table 325 of FIG. 20, to convert the conversion target ID into a converted ID. At next step S323, the transmit unit 25 transmits a repeater signal including the converted ID to the slave device 301 and the master device 303.

Succeeding steps S23 to S25 are the same as those of FIG. 6 and therefore will not again be described.

### 3-3-3. Action Example of Master Device 3

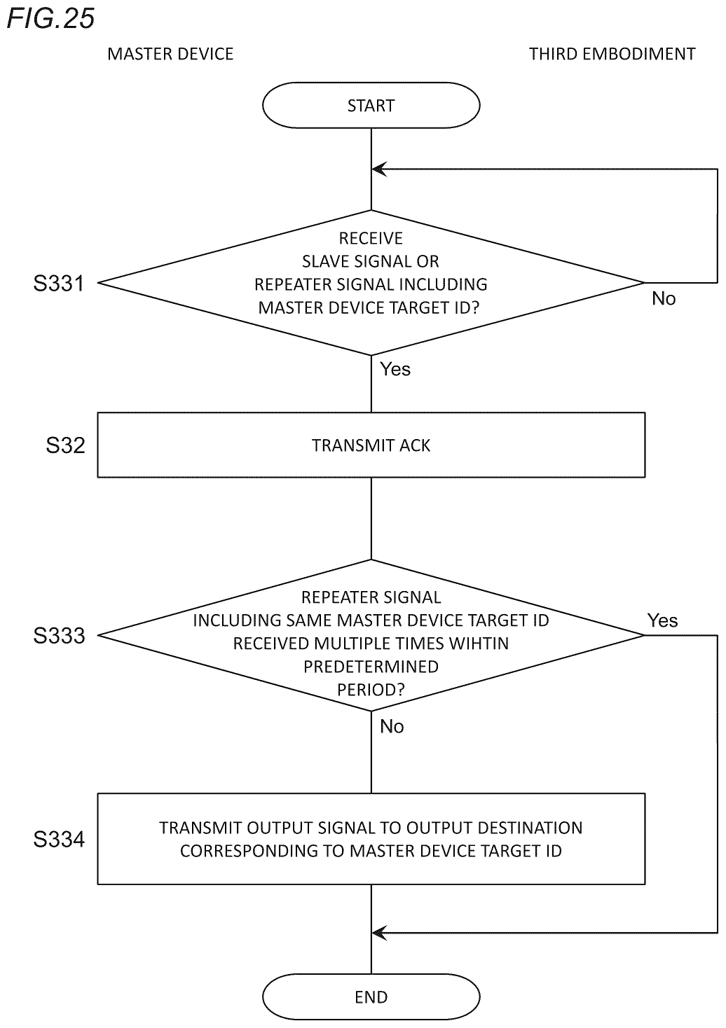

FIG. 25 is a flowchart showing an example of processing executed by the master device 303 of FIG. 21.

In step S331 of FIG. 25, the controller 32 of the master device 303 determines whether the receive unit 36 has received a slave signal or a repeater signal that includes a master device target ID, and if affirmative, goes to step S32, whereas if negative, goes back to step 31.

In step S32 of FIG. 25, the transmit unit 35 transmits an ACK signal to the slave device 301 or the repeater device 302. When the controller 32 determines in step S331 that a slave signal including a master device target ID has been received, the transmit unit 35 transmits an ACK signal including the master device target ID to the slave device 301. On the other hand, when the controller 32 determines in step S331 that a repeater signal including a master device target ID has been received, the transmit unit 35 transmits an ACK signal including the master device target ID to the repeater device 302.

In step S333 of FIG. 25, the controller 32 determines whether a slave signal or a repeater signal that includes the same master device target ID has been received multiple times within a predetermined period, and if affirmative, ends the processing of FIG. 25, but if negative, advances to step S334.

In step S334 of FIG. 25, the output unit 37 refers to the output destination table 335, to transmit an output signal to a device to be controlled that corresponds to the master device target ID included in the signal received in step S331.

### 3-3-4. Action Example of Wireless Communication System 300

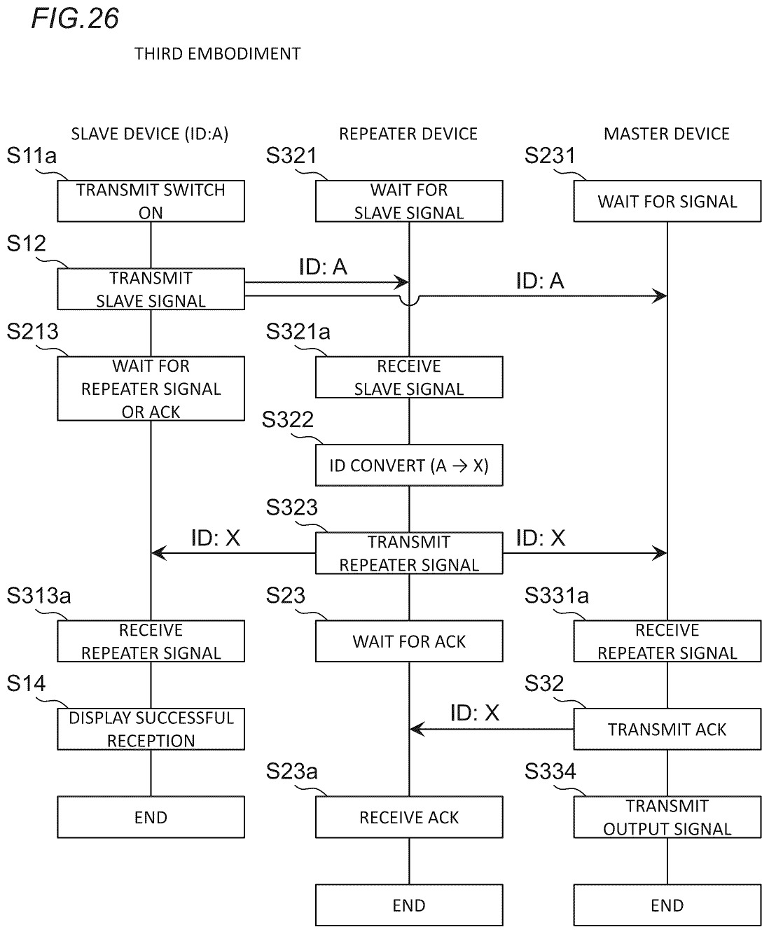

FIG. 26 is a sequence diagram showing an example of overall action of the wireless communication system 300 according to this embodiment.

In FIG. 26, when the user presses and turns on the transmit switch 11 (S11a), the slave device 301 transmits a slave signal to the repeater device 302 in step S12 (see FIG. 23). Here, the ID of the slave device 301 is expressed by “A”. Accordingly, the slave signal includes individual identification information having the ID “A” of the slave device 301 and the type information for specifying that the transmission source is the slave device 301.

At FIG. 26, the repeater device 302 receives the slave signal including the ID “A” (S321a), whereas the master device 303 is unresponsive to the slave signal including the ID “A”. The reason is that the master device target IDs of the output destination table 335 of FIG. 22 do not include the ID “A” and therefore that the slave signal including the ID “A” is not a reception target of the master device 303.

Referring back to FIG. 26, the repeater device 302 converts the ID “A” into ID “X” in step S322 and transmits a repeater signal including the ID “X” to the slave device 301 and the master device 303 in step S323. The slave device 301 receives the repeater signal including the ID “X” (S313a) and, in step S14 (see FIG. 23), notifies the user of information indicating that reception has succeeded.

On the other hand, the master device 303 receives the repeater signal including the ID “X” (S331a) and, in step S32 (see FIG. 25), transmits an ACK signal including the ID “X” to the repeater device 302, while the repeater device 302 receives the ACK signal (S23a). Furthermore, in step S334, the master device 303 refers to the output destination table 335 of FIG. 22, to transmit an output signal to an output destination.

### 3-4. Effects, Etc.

As above, the repeater device 302 according to this embodiment includes the receive unit 26 and the transmit unit 25. The receive unit 26 receives a slave signal transmitted wirelessly from the slave device 301. The slave signal includes first individual identification information. Based on the slave signal, the transmit unit 25 transmits a repeater signal including second individual identification information corresponding to the first individual identification information wirelessly to the slave device 301 and the master device 303. The receive unit 26 further receives an ACK signal responding to the repeater signal, transmitted wirelessly from the master device 303.

According to this configuration, the wireless communication system 300 prevents simultaneous execution of transmission of the ACK signal including specific individual identification information from the master device 303 and transmission of the repeater signal including the same individual identification information as the specific individual identification information from the repeater device 302, resulting no problem of interference between the ACK signal and the repeater signal. As an example, when a slave signal including the first individual identification information reaches the repeater device 302 and the master device 303, the repeater device 302 transmits a repeater signal including the second individual identification information to the slave device 301 and the master device 303, whereupon the repeater signal does not interfere with the ACK signal from the master device 303.

The repeater device 302 may further include the storage 24 and an individual identification information converter 221. The storage 24 stores the ID conversion table 325 that correlates the first individual identification information with the second individual identification information. The individual identification information converter 221 refers to the ID conversion table 325, to convert the first individual identification information included in the slave signal into the second individual identification information. The transmit unit 25 transmits a repeater signal including the second individual identification information to the slave device 301 and the master device 303.

This configuration can also achieve effects similar to those of the above repeater device 302.

The slave device 301 includes the storage 17, the transmit unit 15, the receive unit 16, and the notification unit 18. The storage 17 stores the first and the second individual identification information. The transmit unit 15 transmits a slave signal including the first individual identification information wirelessly to the repeater device 302. The receive unit 16 receives a signal. When the signal received by the receive unit 16 includes the second individual identification information, the notification unit 18 notifies the user of reception success information indicating that reception has succeeded.

According to this configuration, there can be obtained the slave device 301 applicable to the wireless communication system 300 that achieves the effect of no interference between the repeater signal and the ACK signal as above. The user using the slave device 301 can know, by the notification unit 23, success/failure in operation performed using the slave device 301 and in communication between the slave device 301 and the repeater device 302.

The slave device 301 may be capable of transmitting a signal directly to the master device 303 without going through the repeater device 302. In this case, when the signal received by the receive unit 16 includes the first individual identification information, the notification unit 18 notifies the user of the reception success information.

According to this configuration, when lying in a near distance, such as e.g., within the same room, from the master device 303, the slave device 301 can communicate with the master device 303 without going through the repeater device 302.

The master device 303 includes the receive unit 36, the transmit unit 35, and the output unit 37. The receive unit 36 receives a repeater signal including the second individual identification information. When the receive unit 36 receives the repeater signal, the transmit unit 35 transmits an ACK signal including the second individual identification information to the repeater device 302. When the receive unit 36 receives the repeater signal, the output unit 37 outputs a control signal for a device to be controlled that is correlated previously with the second individual identification information.

According to this configuration, there can be obtained the master device 303 applicable to the wireless communication system 300 that achieves the effect of no interference between the repeater signal and the ACK signal as above. The user using the slave device 301 can know, by the notification unit 23, success/failure in operation performed using the slave device 301 and in communication between the slave device 301 and the repeater device 302.

The master device 303 may further include the storage 34 storing the output destination table 335 that correlates the second individual identification information with the output destination information. The output unit 37 refers to the second individual identification information and the output destination table 335, to output a control signal to an output destination indicated by the output destination information.

This configuration can also achieve the effects similar to those of the above master device 303.

The master device 303 may be capable of receiving a signal directly from the slave device 1 without going through the repeater device 302. In this case, the output destination table 335 may further correlate the first individual identification information with the output destination information. The receive unit 36 further receives a slave signal including the first individual identification information. When the receive unit 36 receives the slave signal including the first individual identification information, the transmit unit 35 transmits an ACK signal including the first individual identification information to the slave device 301. The output unit 37 refers to the first individual identification information and the output destination table 335, to output a control signal to an output destination indicated by the output destination information.

According to this configuration, when lying in a near distance, such as e.g., within the same room, from the slave device 301, the master device 303 can communicate with the slave device 301 without going through the repeater device 302.

Although the embodiments of the present disclosure have hereinbefore been described in detail, the above descriptions are mere exemplifications of the present disclosure in all respects. Various improvements or modifications can be made without departing from the scope of the present disclosure.

### EXPLANATIONS OF LETTERS OR NUMERALS

1 slave device
11 transmit switch
12 power generator
13 power accumulator
14 controller
15 transmit unit
16 receive unit
17 storage
18 notification unit
2 repeater device
21 power supply
22 controller
23 notification unit
24 storage
25 transmit unit
26 receive unit
3 master device
31 power supply
32 controller
33 operating unit
34 storage
35 transmit unit
36 receive unit
37 output unit
100 wireless communication system
110 button member
171 ID correlation information
221 ID converter
221 individual identification information converter
300 wireless communication system
301 slave device
302 repeater device
303 master device
325 ID conversion table
335 output destination table

1. A master device receiving a signal directly or via a repeater device from a slave device,
when receiving a slave signal from the slave device, the repeater device transmitting a repeater signal wirelessly to the slave device and the master device,
the master device comprising:
a master device receive unit that receives the slave signal and the repeater signal;
a master device transmit unit that transmits a response signal to the slave device and the repeater device when the master device receive unit receives the repeater signal; and
an output unit that outputs a control signal to a device to be controlled, when the master device receive unit receives at least one of the slave signal and the repeater signal, wherein
when the master device receive unit receives the slave signal, the master device transmit unit transmits the response signal to the slave device and the repeater device after a predetermined wait time.

2. The master device according to claim 1, wherein
the wait time is longer than a time from when the repeater device receives the slave signal to when the repeater device completes transmitting the repeater signal slave device signal.

3. A slave device transmitting a signal directly or via a repeater device to the master device according to claim 1,
the slave device comprising:
a slave device transmit unit that transmits the slave signal wirelessly to the repeater device;
a slave device receive unit that receives the repeater signal and the response signal; and
a slave device notification unit for notifying a user of information, wherein
when the slave device receive unit receives at least one of the repeater signal and the response signal within a predetermined response time from time of transmission of the slave signal by the slave device transmit unit, the slave device notification unit notifies the user of information indicating that reception has succeeded.

4. A repeater device comprising:
a repeater device receive unit that receives a slave signal transmitted wirelessly from a slave device and the response signal transmitted wirelessly from the master device according to claim 1; and
a repeater device transmit unit that transmits the repeater signal wirelessly to the slave device and the master device, based on the slave signal.

5. A wireless communication system comprising:
a master device according to claim 1;
a slave device transmitting a signal directly or via a repeater device to the master device, the slave device comprising:
a slave device transmit unit that transmits the slave signal wirelessly to the repeater device;
a slave device receive unit that receives the repeater signal and the response signal; and
a slave device notification unit for notifying a user of information; and
a repeater device comprising:
a repeater device receive unit that receives a slave signal transmitted wirelessly from a slave device and the response signal transmitted wirelessly from the master device; and
a repeater device transmit unit that transmits the repeater signal wirelessly to the slave device and the master device, based on the slave signal.

6. The wireless communication system according to claim 5, wherein
the wait time is longer than a time from when the repeater device receives the slave signal to when the repeater device completes transmitting the repeater signal slave device signal.

7. The wireless communication system according to claim 5, wherein
the slave device further comprises:
a transmit switch having a button member, the transmit switch performing on-off switching by movement of the button member; and
a power generator that generates electric power using energy generated with movement of the button member, and wherein
the slave device transmit unit transmits the slave signal to at least one of the repeater device and the master device by the electric power.

8. The wireless communication system according to claim 7, wherein
the slave device further comprises a power accumulator that accumulates the electric power, wherein
the slave device receive unit receives at least one of the repeater signal and the response signal by the electric power supplied from the power accumulator, and wherein
the slave device notification unit notifies of the information by the electric power supplied from the power accumulator.

9. The wireless communication system according to claim 8, wherein
the wait time is shorter than power suppliable time during which the power accumulator is capable of supplying the electric power.
